(19) United States
(12) Patent Application Publication
(10) Pub. No.: US 2012/0220360 A1
(43) Pub. Date: Aug. 30, 2012

(54) GAMING MACHINE HAVING A CURVED DISPLAY WITH A VIDEO SWITCHER AND TOUCH ROUTER SYSTEM

(75) Inventors: Bryan M. Kelly, Alamo, CA (US); Stephen Patton, Reno, NV (US); Kiran Brahmandam, Fremont, CA (US); Robert W. Crowder, JR., Las Vegas, NV (US); Vijay Kompella, Las Vegas, NV (US); Jeffrey Lee Allen, Pleasanton, CA (US); John R. Vallejo, Henderson, NV (US); Vernon H. Bernard, II, Henderson, NV (US); Karl E. Wudtke, Las Vegas, NV (US); Frank R. Anderson, Las Vegas, NV (US); Lawrence C. McAllister, Las Vegas, NV (US)

(73) Assignee: Bally Gaming, Inc., Las Vegas, NV (US)

(21) Appl. No.: 13/470,188

(22) Filed: May 11, 2012

Related U.S. Application Data
(63) Continuation of application No. 12/464,046, filed on May 11, 2009.
Application No. 12/464,046 is a continuation-in-part of application No. 12/271,781, filed on Nov. 14, 2008, now Pat. No. 8,137,185.
Application No. 12/271,781 is a continuation-in-part of application No. 12/271,802, filed on Nov. 14, 2008.
Application No. 12/271,781 is a continuation-in-part of application No. 11/209,895, filed on Aug. 23, 2005, now Pat. No. 7,479,065.
Application No. 12/271,802 is a continuation-in-part of application No. 11/209,895, filed on Aug. 23, 2005, now Pat. No. 7,479,065.
Application No. 11/209,895 is a division of application No. 09/690,289, filed on Oct. 16, 2000, now Pat. No. 6,942,571.
Application No. 12/464,046 is a continuation-in-part of application No. 12/350,938, filed on Jan. 8, 2009.
Application No. 12/350,938 is a continuation-in-part of application No. 12/350,939, filed on Jan. 8, 2009.
Application No. 12/350,938 is a continuation-in-part of application No. 11/470,606, filed on Sep. 6, 2006.
Application No. 12/350,939 is a continuation-in-part of application No. 11/470,606, filed on Sep. 6, 2006.
Application No. 12/350,938 is a continuation-in-part of application No. 11/938,746, filed on Nov. 12, 2007.
Application No. 12/350,939 is a continuation-in-part of application No. 11/938,746, filed on Nov. 12, 2007.
(60) Provisional application No. 60/714,754, filed on Sep. 7, 2005.

(51) Int. Cl. A63F 13/00

(52) U.S. Cl. 463/20; 463/34; 463/31

(57) ABSTRACT

Gaming machines projecting video images onto a curved display are disclosed herein. A display manager receives one or more video signals from a controller and one or more video signals from the system device and displays one or multiple video signals on the curved display. The display manager sends the multiple video signals to a projector which projects the multiple video signals on the curved display. The curved display may be split between multiple signals, or one or more signals may overlay one or more background signals. The overlaid signals may completely obscure the background signals, or they may provide a level of transparency by allowing the background signal to be partially or completely visible. The display manager the video signals regarding how to split, overlay, superimpose, and otherwise share the display among the video input signals.

### CROSS-REFERENCE TO RELATED APPLICATIONS

This application is a continuation of U.S. patent application Ser. No. 12/464,046, filed May 11, 2009, now U.S. Pat. No. 8,177,638, issued May 15, 2012 which is a continuation-in-part of U.S. patent application Ser. Nos. 12/271,781 and 12/271,802 both of which were filed Nov. 14, 2008, and both of which are continuation-in-parts of U.S. patent application Ser. No. 11/209,895 filed Aug. 23, 2005, which is a divisional of U.S. patent application Ser. No. 09/690,289, now U.S. Pat. No. 6,942,571, which are both hereby incorporated by reference.

U.S. patent application Ser. No. 12/464,046 is also a continuation-in-part of U.S. patent application Ser. Nos. 12/350,938 and 12/350,939, both of which were filed Jan. 8, 2009, and both of which claim the benefit of U.S. provisional Patent Application Ser. No. 61/019,082, filed Jan. 8, 2008, which are all hereby incorporated by reference. U.S. patent application Ser. Nos. 12/350,938 and 12/350,939 are also continuation-in-parts of U.S. patent application Ser. No. 11/470,606, filed Sep. 6, 2006, which claims the benefit of U.S. provisional Patent Application Ser. No. 60/714,754, filed Sep. 7, 2005, which are all hereby incorporated by reference. U.S. patent application Ser. Nos. 12/350,938 and 12/350,939 are also continuation-in-parts of U.S. patent application Ser. No. 11/938,746, filed Nov. 12, 2007, which are all hereby incorporated by reference. U.S. patent application Ser. Nos. 12/350,938 and 12/350,939 are also related to U.S. patent application Ser. No. 11/307,528, filed Feb. 10, 2006, which is hereby incorporated by reference.

This application is also related to U.S. patent application Ser. No. 12/463,940 concurrently filed on May 11, 2009, entitled GAMING MACHINE HAVING A MOLDED CURVED DISPLAY, which is hereby incorporated by reference.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### TECHNICAL FIELD

This description relates generally to gaming systems and machines, and more particularly to gaming systems and machines having a curved display.

### BACKGROUND

Gaming machines have been developed having various features to capture and maintain player interest. Some features are directed to increasing or providing the player with the opportunity to win larger sums of money. For example, gaming machines may include second chance games that provide a player with additional opportunities to obtain a winning outcome. Alternatively, gaming machines may be tied into progressive gaming systems that award large progressive jackpots.

In addition to providing players with more opportunities to obtain a winning outcome or win a large sum of money, gaming machines have increased the number of features and grown in sophistication in order to increase player participation or interest in a game. For example, the mechanical reels of traditional gaming machines have been replaced with video depictions of spinning reels. These video gaming machines provide a richer gaming experience for players by including graphics or animation as part of the game. However, overly complex video displays on a gaming machine may turn off player participation because players become frustrated with the game or are unwilling to learn or decipher all the information provided on the video display. Accordingly, there is a continuing need for slot machines variants that provide a player with enhanced excitement without departing from the original slot machine gaming concept.

### SUMMARY

Briefly, and in general terms, various embodiments are directed to a gaming system for presenting both game content-based video signals and secondary video signals in a single presentation. In one embodiment, the gaming system includes a touch screen display, a curved display system, a gaming controller, a secondary video source, a touch router device, and a display manager. The touch screen display is configured to display video signals. The curved display system including a curved transparent material and a projector for projecting video images onto the curved transparent material. The gaming controller is configured to generate a first video signal including game content to be viewed on the curved display system. The secondary video source is configured to generate a second video signal including secondary content to be viewed on the curved display system. The touch router device is in communication with the touch screen display. The display manager is configured to scale at least one of the first video signal or the second video signal to a reduced size and render the first video signal from the gaming controller with the second video signal from the secondary video source. The touch screen display receives an input that corresponds to coordinates and calculates a coordinate transformation on the coordinates that correspond to a determined source to accommodate any scaling performed on at least one of the first video signal or the second video signal, which results in transformed coordinates.

In another embodiment, the gaming system includes a touch screen display, a curved display system, a primary video source, a secondary video source, a touch router device, and a display manager. In this embodiment, the primary video source is configured to generate a first video signal to be viewed on the curved display system. This embodiment also includes the display manager which is configured to scale at least one of the first video signal or the second video signal to a reduced size and render the first video signal with the second video signal. The display manager sends the first and second video signals to the projector for simultaneously displaying the first and second video signals on the curved transparent material.

In addition to gaming machines, various embodiments of a gaming system having touch panels as user control devices are disclosed herein. According to one embodiment, the gaming system includes a curved display system for displaying a game. The curved display system has a curved material having an outer surface, an inner surface, and a radius of curvature similar to a mechanical reel. The curved display system also includes a digital light projection device for projecting images of one or more reels onto the curved material. The gaming system also includes a touch screen system positioned in front of the curved material. The touch screen system includes a touch sensor assembly having a substantially transparent touch panel that produces touch data when activated, a touch panel controller for controlling and interpreting the touch data, and touch panel software for controlling and interpreting touch data. The touch panel is configured to select one or more pay lines for the game. In yet another embodiment, the touch panel is configured to add reel strips to the game, remove reel strips from the game, add game indicia to the reel strips, or remove game indicial from the reel strips. In one embodiment, the display manager causes the first video signal from the master gaming controller and the second video signal from the secondary video source to be displayed simultaneously on the curved transparent material using the light emitting diode projector.

In certain embodiments, the display manager scales the first and second video signals to a desired size that conforms to the size and shape of the curved transparent material and renders the first video signal from the gaming controller adjacent to the second video signal from the secondary video source in a split screen format. In another embodiment, the display manager may overlay the second video signal from the secondary video source on the first video signal from the gaming controller on the curved display system. The overlaid second video signal from the secondary video source obscures at least a portion of the first video signal from the gaming controller. In one embodiment the overlaid second video signal from the secondary video source includes a level of transparency enabling the first video signal from the master gaming controller to be at least partially visible through the second video signal. In another embodiment, the display manager overlays the second video signal from the secondary video source on the first video signal from the master gaming controller with different levels of transparency in different areas of the curved display system.

The display manager may further include a touch router device in communication with a touch display positioned in front of the curved display system. The gaming controller, the secondary video source, and the touch router device receive touch signals including physical coordinates of a touch from the touch display. The touch router device determines a source of the video image displayed on the curved display system at the physical coordinates of the touch.

Other features and advantages will become apparent from the following detailed description, taken in conjunction with the accompanying drawings, which illustrate by way of example, the features of the various embodiments.

### BRIEF DESCRIPTION OF THE DRAWINGS

FIG. 1 is a perspective view of one embodiment of a gaming machine having a curved display.

FIG. 2 is a schematic diagram of the components of a curved display system.

FIG. 3 is an exploded view of the curved display system of FIG. 1.

FIG. 4 is an exploded view of another embodiment of a curved display system.

FIG. 5 is an exploded view of one embodiment of a curved display system having a touch panel system.

FIG. 6 is one embodiment of an exploded perspective view of the touch panel system of FIG. 5.

FIG. 7 is an operational flow diagram of a gaming machine having a touch panel system.

FIG. 8 is an operational flow diagram of a gaming machine having a touch panel system.

FIGS. 9A-9B illustrate one embodiment of a touch gesture for initiating a game presented on a gaming machine.

FIGS. 10A-10B illustrate one embodiment of a touch gesture for selecting active pay lines.

FIGS. 11A-11C illustrate touch gestures for adding and removing reels from a game.

FIGS. 12A-12B illustrate one embodiment of a touch gesture for moving symbols between reels of a game.

FIGS. 13A-13D illustrate touch gestures for adding and removing symbols from reels of a game.

FIG. 14 is a perspective view of one embodiment of a curved display system for a video gaming machine.

FIG. 15 is a perspective view of another embodiment of a gaming machine having a curved display and a secondary display positioned above the curved display.

FIG. 16 is a perspective view of an embodiment of a gaming machine having a main curved display system and a secondary curved display system.

FIGS. 17A-17B are perspective views of an embodiment of a gaming machine having a main curved display system and a secondary display system composed of a LCD positioned in front of a curved display system.

FIG. 17C is a perspective view of another embodiment of a gaming machine having a curved display.

FIG. 18 is a schematic representation of one embodiment of a gaming system including one or more gaming machines having curved displays.

FIG. 19 is a perspective view of yet another embodiment of a gaming machine having a curved display

FIG. 20 is a perspective view of the gaming machine of FIG. 19 with the main door opened.

FIG. 21 is a cutaway, side view of the gaming machine of FIG. 19.

FIG. 22 is a component diagram of a Display Manager connected to components of an Electronic Gaming Machine and Player Tracking Device.

FIG. 23 is a component diagram of the components of the Display Manager.

FIGS. 24A and 24B are component diagrams of the Touch Router.

FIGS. 25A through 25C are diagrams of different screen splitting embodiments that may be projected onto a curved display.

FIG. 26 is a diagram demonstrating how the Video Switcher scales video.

FIG. 27 is a diagram demonstrating super imposing one video stream over another on a curved display.

FIG. 28 is a logic diagram charting a touch screen signal from a patron's touch to the final software endpoint receiving the relative pixel screen coordinate.

FIG. 29 is a component diagram demonstrating a current configuration of a gaming system using a digital light projection (“DLP”) device to project an image onto a display.

FIG. 30 is a component diagram depicting the components a Display Manager embodiment.

FIG. 31 is a component diagram of one embodiment of a Display Manager.

FIGS. 32-34 are diagrams of different screen splitting embodiments.

FIG. 35 is a diagram depicting re-mapped game touch coordinates.

FIG. 36A is a component diagram depicting the video connectivity mapping of an embodiment including a video cabinet with a top monitor and a projection device, such as a digital light projection device, for projecting an image onto a display, where one Display Manager drives both the top monitor and the projection device.

FIG. 36B is a component diagram depicting the touch connectivity mapping of the embodiment shown in FIG. 36A.

FIG. 37A is a component diagram depicting the video connectivity mapping of an embodiment including a video cabinet with a top monitor and a DLP device for projecting an image onto a display, where one Display Manager drives only the top monitor.

FIG. 37B is a component diagram depicting the touch connectivity mapping of the embodiment shown in FIG. 37A.

FIG. 38A is a component diagram depicting the video connectivity mapping of an embodiment including a video cabinet with a DLP device for projecting an image onto a display, where one Display Manager drives the DLP device.

FIG. 38B is a component diagram depicting the touch connectivity mapping of the embodiment shown in FIG. 38A.

FIG. 38C is a component diagram depicting the video connectivity mapping of an embodiment including a video cabinet with a DLP device for projecting an image onto a display, where the game CPU drives the DLP device.

FIG. 38D is a component diagram depicting the touch connectivity mapping of the embodiment shown in FIG. 38C.

FIG. 39 is a component diagram of an embodiment of an iVIEW.

FIG. 40 is a component diagram of an embodiment of a fully-featured iVIEW with two VGA outputs.

FIG. 41 illustrates a Display Manager combining the screen content from two or more sources without affecting the physical construction of the devices connected thereto.

FIG. 42 illustrates installation and configuration of the Display Manager software and hardware.

FIG. 43 illustrates Display Manager configuration screens.

FIG. 44 illustrates a component diagram of the Display Manager shown in connection the Master Gaming Controller, the iVIEW, the touch screen and the DLP device.

FIG. 45 illustrates a video connection and the touch screen control diagram of the Display Manager shown in connection the Master Gaming Controller, the iVIEW, the touch screen and the DLP device.

FIG. 46 is a logic flow diagram illustrating the Display Manager's basic functions.

FIG. 47 is a logic flow diagram illustrating uncarded direct messages using the Display Manager system.

FIG. 48 is a logic flow diagram illustrating carded direct messages using the Display Manager system.

FIG. 49 is a logic flow diagram illustrating the additional Display Manager functions.

FIG. 50 is a logic flow diagram illustrating the additional serial touch screen functions.

### DETAILED DESCRIPTION

Various embodiments are directed to gaming machines having video depictions of one or more mechanical reels projected onto a curved display. According to one embodiment, a digital light processing (DLP) projector that presents video images of one or more reels on the curved display. In one embodiment, the curved display is shaped to simulate the look of mechanical reels. Additionally, the high resolution of the DLP projector presents video images that give a player the impression that the combination of the curved display and the video images are physical, mechanical reel strips.

In other embodiments, shrouds (either physical or video-depictions of the shrouds) may be placed between the video depiction of the reels to provide a more realistic impression of mechanical reels. Optionally, the gaming machines may include other audio and visual features to enhance the perception that the video images and curved display are mechanical reels. For example, the video images may shudder to simulate the torque of stopping the spinning mechanical reels. Alternatively, the video images may have visual imperfections to simulate mechanical reels. Furthermore, audio sound effects may be coordinated with the movement and stopping of the reels to further simulate a gaming machine having mechanical reels.

Because the gaming machine is video-based, the gaming machine also maintains the flexibility of a video gaming machine. For example, the DLP projector may present pay lines directly on and/or around the symbols that comprise a winning outcome. The pay lines may be animated or otherwise highlight the winning combination of symbols. Optionally, the winning symbols may be animated on the “virtual” reel strip. For example, the symbols that form a winning pay line may interact with one another or the symbols may be emphasized by expanding the size of the symbol. Alternatively, a short animated movie may be presented at one or more of the game indicia on a winning pay line. In another embodiment, the images of the game indicia on the “virtual” strips may be altered so that a “wild” symbol morphs into the game indicia that forms a winning combination. For example, a “wild” symbol may morph into a “7” to complete a winning combination of “7-7-7.” In yet another embodiment, the reel strip color may be altered in response to a particular game outcome or trigger for a bonus game.

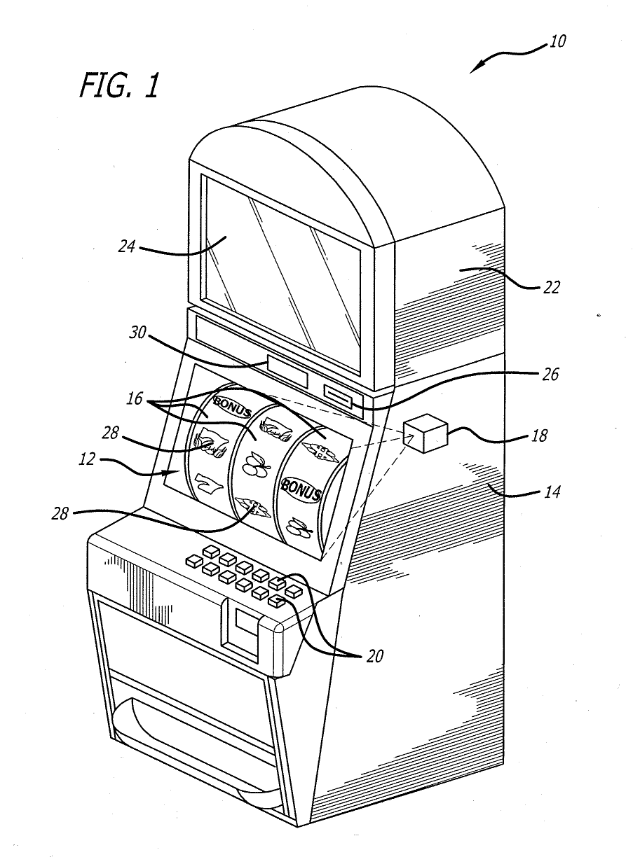

Referring now to the drawings, wherein like reference numerals denote like or corresponding parts throughout the drawings and, more particularly to FIGS. 1-18, there are shown various embodiments of a gaming machine having a curved display system. More specifically, as shown in FIG. 1, the gaming machine 10 includes a curved material 12 positioned within the main gaming cabinet 14. A video image 16 of one or more mechanical reels is projected onto the curved material 12 by a digital light projection (DLP) device 18 or other light projection system. In one embodiment, the DLP device 18 is a Samsung P400 LED projector. As shown in FIG. 1, the video image 16 depicts an image of three mechanical reels. In another embodiment, the video image 16 may depict video images of five mechanical reels.

It is contemplated that the video image 16 may present any number of reels ranging from one reel to five or more reels. In another embodiment, the gaming machine may include a combination of one or more mechanical reels and video images of one or more reels presented on a curved display. The DLP device may project one or more video images 16 onto the curved display 12. Accordingly, it is possible to present a game that is a combination of mechanical reels as well as video reels. The video reels may be part of the primary game or may be presented as a portion of a secondary game.

As shown in FIG. 1, the video image 16 of each of reels also presents one or more game indicia 28. In one embodiment, the video image of each reel includes three game indicia. In another embodiment, the video image of each reel includes four game indicia, thereby increasing the number of paylines available for wagering. Optionally, the game indicia 28 may be animated when the indicia 28 is a component of a winning outcome on an active pay line. Alternatively, the game indicia 28 morphs into a symbol that forms a winning outcome. For example, a “wild” symbol will morph (i.e., change into) a symbol that will form a winning outcome. Accordingly, for a winning outcome of “cherry-wild-cherry,” the “wild” symbol will change into a “cherry” symbol.

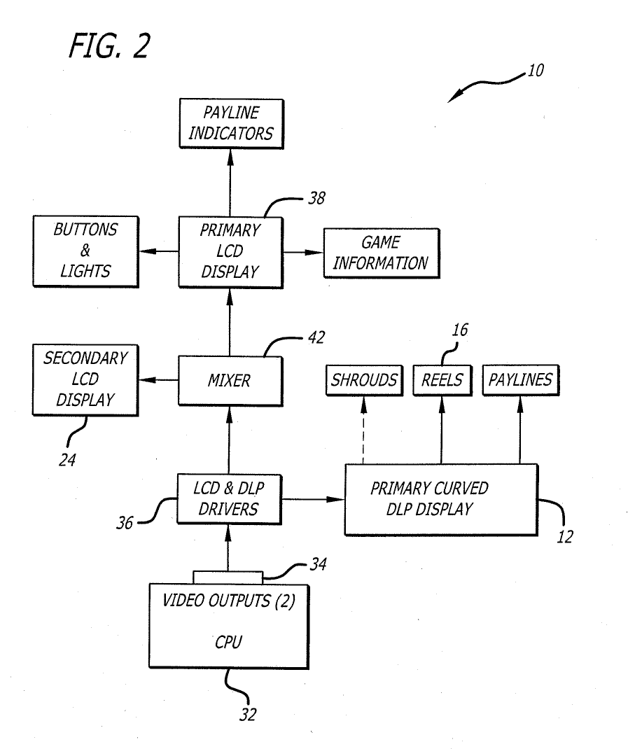

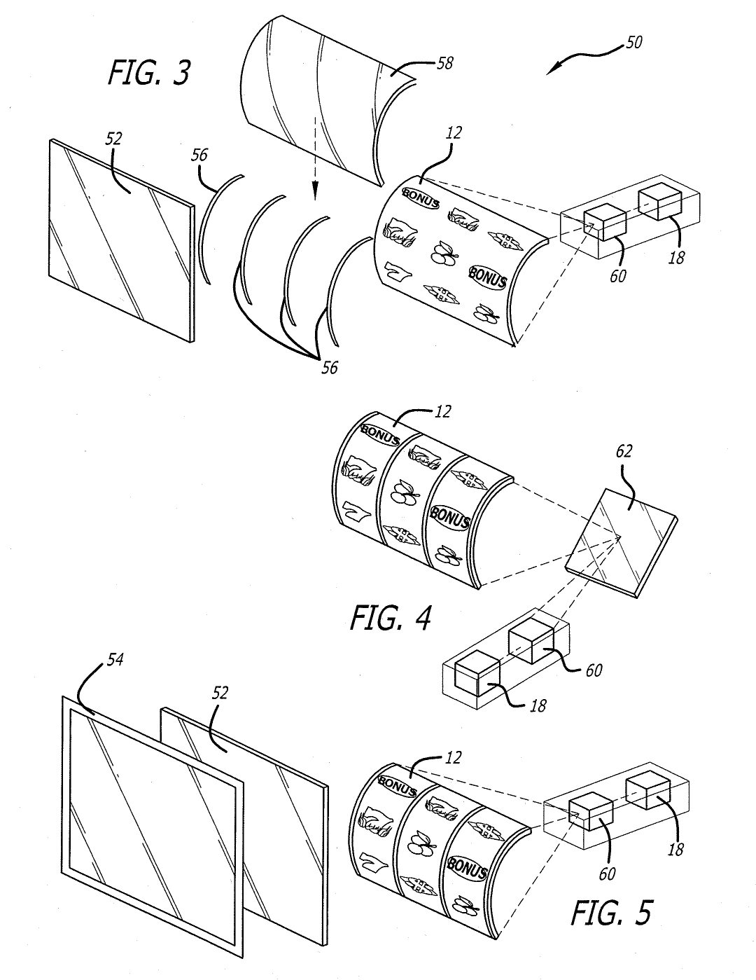

FIG. 2 illustrates a schematic diagram of the components of one embodiment of a gaming machine 10 having a curved display system. The gaming machine 10 includes a micro-controller with a central processing unit (CPU) 32 one or more video outputs 34, and a system memory (not shown). The CPU 32 is in communication with a LCD and DLP control driver 36 via video outputs 34. As shown in FIG. 3, the LCD and DLP control drivers 36 are integral components. In other embodiments, it is contemplated that the LCD and DLP control drivers are separate components. The LCD control driver 36 interfaces with primary LCD display 38 and the secondary LCD display 24 via a mixer 42. In another embodiment, the LCD control driver 36 may directly interface with the primary 38 and secondary displays 24.

The primary LCD display 38 may be used to display buttons and lights, pay line indicators, and other game information such as, but not limited to, credits available, credits won, wager size, wager per pay line, or wager denomination. The secondary LCD display 24 may be used to display other game related information such as, but not limited to, one or more bonus games, pay tables, game theme information, jackpot information, progressive jackpot information, jackpot meters, or the like. The secondary LCD 24 may also display non-gaming related information such as, but not limited to, player account information, advertisements, casino promotions, news, one or more sporting events, or the like.

FIGS. 3-5 illustrate exploded views of various embodiments of a curved display system 50. The curved display system 50 is described by relating the components of the curved display system in relation to layers with the outermost layer in front of the gaming cabinet 14 (i.e., outer layer is closest to the game patron) and the innermost layer located within the gaming cabinet.

As shown in FIG. 3, the outermost layer of a transparent material. The transparent material 52 may be flush with the gaming cabinet 14 or slightly recessed within the gaming cabinet. In one embodiment, the transparent material 52 may be one or more layers of glass, polycarbonate, plexiglass, or other transparent material known or developed in the art. The transparent material may also include printed graphics or a printed frame around the perimeter of the transparent material. In another embodiment, the transparent material 52 may be one or more LCD displays. In yet another embodiment, the transparent material 52 or the LCD displays may also include a touch screen system 54, as shown in FIG. 5.

Referring to FIG. 3, one or more shrouds 56 are placed in front of the curved material 12. The shrouds are physical pieces of material positioned in front of the curved material. The shrouds 56 are placed between the images of the reels 16 that are projected onto the curved material 12 and give the player the impression of separate reel strips. The shrouds 56 may be placed directly on the curved material 12. In another embodiment, the shrouds 56 may be positioned between the transparent material 52 and the curved material 12. In yet another embodiment, the shrouds 56 are placed on the transparent material 52. In another embodiment, the shrouds are video images that are placed between the video images of the reels.

As shown in FIGS. 3-5, a curved material 12 is positioned behind the transparent material 52. In one embodiment, a portion of the curved material 12 touches the transparent material 52. Alternatively, the curved material 12 is in spaced relation to the transparent material 52. The curved material 12 is made of a material that is optically clear such as, but not limited to, glass, polycarbonate, plexiglass, acrylic, or the like. The curved material 12 has a radius of curvature similar to the radius of curvature of a mechanical reel. The curved material 12 may include diffusion or beaded refractive technology. The curved material 12 is generally high contrast, high resolution, and maximum uniformity. According to one embodiment, the radius of curvature is approximately 4.5″ and dimensions of approximately 16.5″ wide and 5.75″ tall. However, as those skilled in the art will appreciate, the curved material may have any width, height, or radius of curvature that approximates or simulates the appearance of a mechanical reel. A shown in FIG. 3, the curved material 12 is a single piece of material. In another embodiment, two or more pieces of a curved material may be used to form a curved display. In one embodiment, the pieces may be slightly spaced apart to give the appearance of separate reels.

As shown in FIG. 3, glossy coating 58 is applied to the outer surface of the curved material 12. In another embodiment, the outer surface of the curved material 12 is polished to a finish having a glossy or reflective properties. The glossy finish reflects light to further simulate or mimic a mechanical reel. Optionally, a finish or coating 58 may be applied to the inner surface of the curved material to improve the appearance of the images projected on the inner surface, as shown in FIG. 3.

In another embodiment, the glossy coating 58 may be replaced with a gradient coating provided on the outer and/or inner surfaces of the curved material 12. The gradient coating provides greater depth of the image projected onto the curved material. The gradient coating may be darker at the periphery of the curved material 12 and lighter in the middle of the curved material. Alternatively, the gradient coating is darker in the middle of the curved material 12 and lighter about the periphery of the curved material. In yet another embodiment, the gradient coating is provided in addition to the glossy coating. For example, the gradient coating and the glossy coating both may be applied to the outer surface of the curved material 12. Alternatively, the glossy coating is applied to the outer surface of the curved material 12 and the gradient coating is applied to the inner surface of the curved material.

In another embodiment, a diffusion screen (not shown) is provided in front of or behind the curved display 12. Alternatively, the diffusion screen is coupled directly to the front and/or the back surface of the curved display 12. The diffusion screen may be made from a thin, semi-flexible, acrylic optical beads. In one embodiment, a rigid metal frame encapsulates the diffusion screen to help achieve a uniform and repeatable manufacturing of the screen.

As shown in FIGS. 3-5, a DLP device 18 is positioned behind the curved material 12. The DLP device 18 projects video images onto the inner surface of the curved material 12. The DLP device 18 generally includes a DLP chip, a flywheel color filter, and a light source. In one embodiment, the light source is a high intensity discharge (HID) projector. In another embodiment, the light source is a light emitting diode (LED) projector.

The DLP device 18 may directly project video images onto the inner surface of the curved material 12 as shown in FIGS. 3 and 5. Alternatively, the video image is indirectly projected onto the inner surface of the curved material by reflecting the video images off a mirror 62, as shown in FIG. 4. In one embodiment, the DLP device 18 projects an image having a display resolution of 800×600, 1280×720, 1280×1024 or 1980×1080. As those skilled in the art will appreciate, these resolution values may be approximate as the resolution may be lower or higher than the cited resolution values. For example, the DLP device 18 may project an image of a plurality of reels onto the curved material having a resolution of approximately 1360×768. The DLP device 18 may have an aspect ratio of approximately 16:9 or any other aspect ratio depending on the size of the curved material 12. Generally, the DLP device will have a brightness of approximately 300 to approximately 500 ANSI Lumens. The color depth may be 8-bit, 16.7M colors. As those skilled in the art will appreciate, the DLP device may have any brightness or color depth.

As shown in FIGS. 3-5, a lens 60 is positioned between the curved material and the DLP device 18. In one embodiment, the lens 60 may be an anamorphic lens may be used to shorten or stretch the image to an appropriate size. In other embodiments, a video scaler or other software may be used to reduce or increase the size of the image in order for the image to fit within the curved display. In another embodiment, the larger image may still be projected (i.e., overscan) onto the curved material, but the extra image that is over-projected is not visible to the game patron as a screen or other partition is used to block out the periphery of the curved material. The over-projection allows the operator to digitally adjust the image of the reels and account for any tolerances that may not be maintained during the assembly of critical optical components including, but not limited to, the projector, mirror, or screens. In one embodiment, the image is over-projected by approximately 0.4 inches. As those skilled in the art will appreciate, the amount of over-projection may be a larger or smaller value depending upon the tolerances maintained during the assembly process.

In some embodiments, the edges of the projected image are bowed/distorted, thereby creating a fish-eye effect. This effect may be corrected using warping software and/or hardware to correct the projected image. In another embodiment, a warping template, which is previously created for a particular hardware configuration, may be applied to correct the projected image.

FIG. 4 illustrates a curved display system 50 in which the image of the reels is indirectly projected onto the curved material 12. The curved display system 50 includes a short-throw lens 60 and a front-coated mirror 62 to achieve the necessary image size while working with the dimensional constraints (i.e., depth) of the gaming cabinet 14. Otherwise stated, the DLP device 18 requires a particular throw distance in order to project a particular image size, but the gaming cabinet 14 is not large enough to accommodate such a throw distance. For example, according to one embodiment, the combination of the short-throw lens 60 and the front-coated mirror 62 provides a throw distance of approximately 25 inches.

In alternate embodiments, a combination of a short-throw lens 60 and a back-coated mirror may be used to achieve the proper throw distance for the DLP device 18. In another embodiment, a combination of a short throw-lens and two or more mirrors may be used to achieve the proper throw distance. In other embodiments, two or more mirrors may be used to provide the appropriate light path length while reducing the overall depth of the enclosure. In yet another embodiment, the gaming cabinet (not shown) is sized to allow the DLP device 18 to directly project an image onto the curved display 12 without needing a short-throw lens and/or any mirrors.

FIG. 5 illustrates another embodiment of a curved display system 50 having a touch screen 54 placed in front of the curved display 12. As shown in FIG. 5, the touch screen 54 is a flat surface that is spaced apart from the curved display 12, as disclosed in U.S. patent application Ser. No. 11/209,895, filed Aug. 23, 2005, which is hereby incorporated by reference. In another embodiment, the touch screen 54 is curved to conform to or approximately conform to the shape of the curved display.

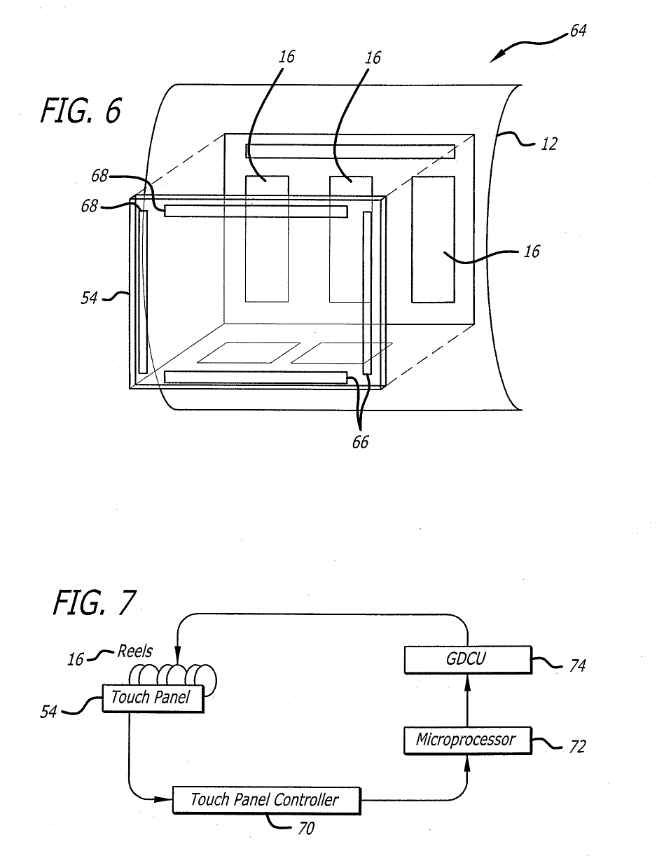

FIGS. 6-8 illustrate one embodiment of a touch sensor assembly 68 incorporating a substantially transparent touch panel 54, a touch controller 70, and touch panel software. As shown in FIG. 6, the touch panel 54 utilizes the touch sensor assembly 68 to produce touch data when touched or activated, as well as allowing substantially unobstructed viewing of the projected images of the reels shown on the curved display 12 behind the touch panel. The touch sensor assembly 68 includes one or more touch pad areas (not shown), one or more touch transducers 66, wave reflectors (not shown), cabling (not shown), a bezel (not shown), a touch panel controller 70, touch panel driver software, and touch panel application software. The material for the touch pad areas (not shown), is either glass or other polymeric material suitable for propagating surface acoustic waves.

Additionally, the transducers 66 are able to adhere to the skin of the glass-like materials of the touch panel 54 sufficiently to pass around curves. This allows a curved touch panel (not shown) to be utilized without detrimental effects. Accordingly, in one embodiment, the touch panel 54 has a radius of curvature similar to the curved display 12. Also, one of ordinary skill in the art will appreciate that while the touch panel 54 is shown to be rectangular in shape with respect to FIG. 6, the touch panel may be designed to accommodate the shape of any gaming machine configuration (e.g., circle, semi-circle, triangle, and the like).

As shown in FIG. 7, the touch panel 54 is placed in front the projected images of the reels 16. Touch panel data received by the touch panel 54 is transmitted to the touch panel controller. The touch panel controller 70 acts to control and interpret touch data from the touch panel 54. The controller 70 typically includes a printed circuit board assembly, often encased inside a metal or plastic housing with mounting holes. In one embodiment, the controller 70 is mounted to the inside of the gaming machine door or cabinet, and is preferably within reach of the touch panel wiring (not shown). The controller 70 is wired to the appropriate power and communication connections within the gaming machine. The controller 70 outputs a data stream consisting of touch coordinate information.

In one embodiment, the microprocessor 72 runs an application that translates the touch panel controller 70 serial touch information into reel control commands for the GDCU reel controller 74. The application uses drivers to communicate with the GDCU 74 which controls the projection of the image onto the curved display 12. The GDCU 74 is a communications portion of the gaming machine 10 which “talks” to the different components of the gaming machine.

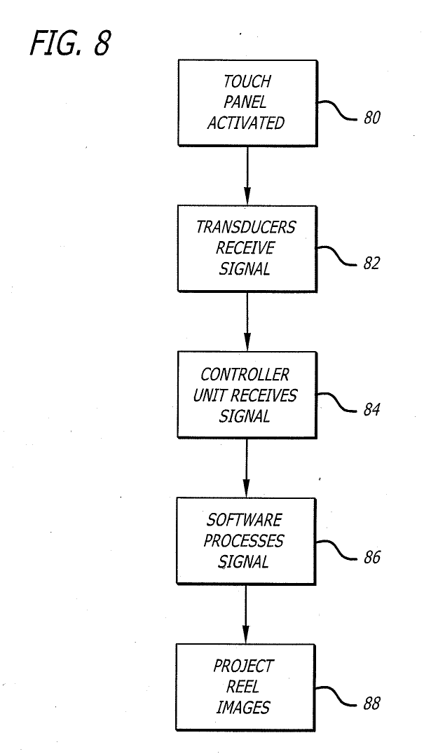

FIG. 8 illustrates the operational flow of a gaming machine including a touch panel system. As shown in FIG. 8, the logical operations of the various embodiments of the touch screen system are implemented (1) as a sequence of computer implemented steps or program modules running on a computing system and/or (2) as interconnected machine logic circuits or circuit modules within the computing system. The implementation is a matter of choice dependent on the performance requirements of the computing system implementing the touch panel system. Accordingly, the logical operations making up the embodiments of the touch panel system described herein are referred to variously as operations, structural devices, acts or modules. It will be recognized by one skilled in the art that these operations, structural devices, acts and modules may be implemented in the system, in firmware, in special purpose logic, analog circuitry, or any combination thereof.

As shown in FIG. 8, the logical operations of a touch panel system 64 utilize the components of the system in a logical sequence. In the panel activation step 80, the touch panel 54 is activated. This occurrence produces a signal that is received by the transducers 66 associated with the touch panel 54 in the transducer signaling step 82. In the controller signaling step 84, a signal is sent to the touch panel controller 70 reporting the activation of the touch panel 54. From the touch panel controller 70, a signal is then sent to, and interpreted by, the touch panel software (which is in the microprocessor 70) in the signal processing step 86. Finally, the touch panel software sends a signal to the GDCU reel controller 74 to activate the DLP device 18 in the mechanical activation step 88.

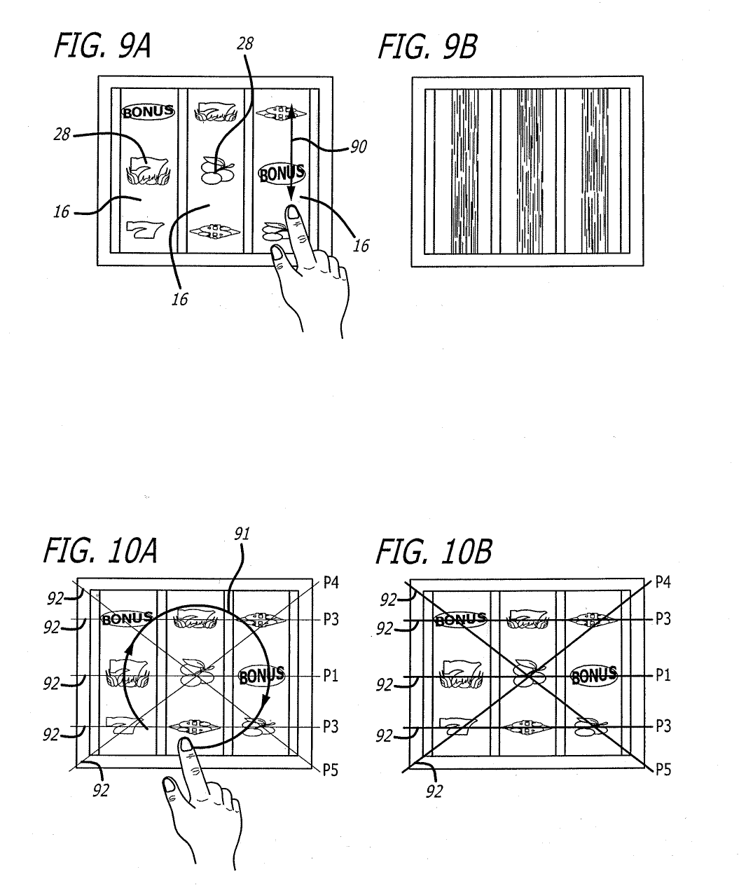

The touch panel system 64 is adapted to detect and interpret different types of touch data. For example, FIGS. 9A-9B illustrate one embodiment in which touch data in the form of a touch gesture 90 generally parallel to the reels will cause the projected image of the reels to spin. The touch gesture in a “slide up” or “slide down” motion will initiate the spinning of the reels as shown in FIG. 9B. The gesture causes the reels to spin in the particular direction of the gesture. For example, if the gesture moves top-down on the touch screen, the reels spin in a top-down direction. Alternatively, if the gesture moves bottom-up on the touch screen, the reels spin in a bottom-up direction. Additionally, the speed of the gesture may affect the speed of the spinning of the reels. For example, if the gesture is fast, the reels spin fast whereas the reels will spin slower for a slower gesture. Generally, any gesture on the touch screen that is parallel to the image of the reels will cause all the reels to spin. In another embodiment, the player needs to make a gesture at a particular area adjacent to the image of the reels in order to cause the image of the reels to spin. In yet another embodiment, the player can gesture to control each reel. Accordingly, the player may vary the order and/or speed of each reel spun.

FIGS. 10A-10B illustrate touch gestures related to placing a wager or selecting a pay line. For example, in one embodiment, touch data sensed at the location near a pay line will result in the selection of the pay line for play. If the touch data is a circular motion 91 that covers one or more paylines 92, this touch gesture is interpreted as selecting two or more pay lines, as shown in FIG. 10A. For example, the circular gesture encompasses or touches all pay lines, and then all the pay lines are selected. Alternatively, if the circular gesture only encompasses three pay lines, those three pay lines are selected for play. As shown in FIG. 10B, the pay lines located within the touch gesture are highlighted on the screen and active for game play.

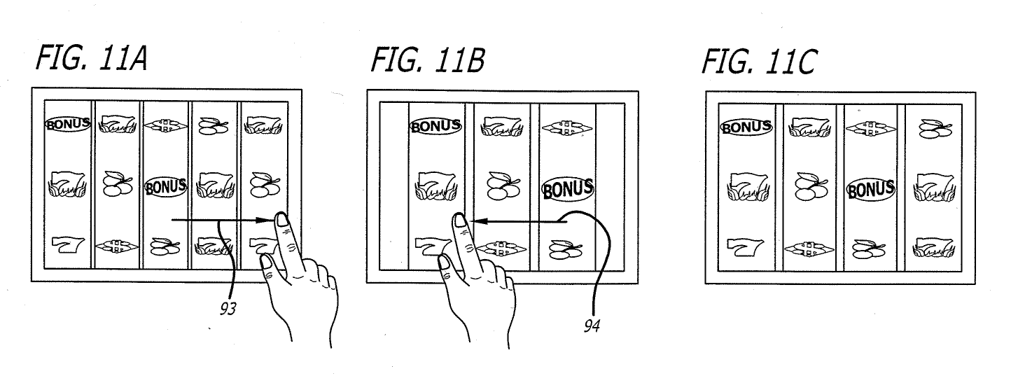

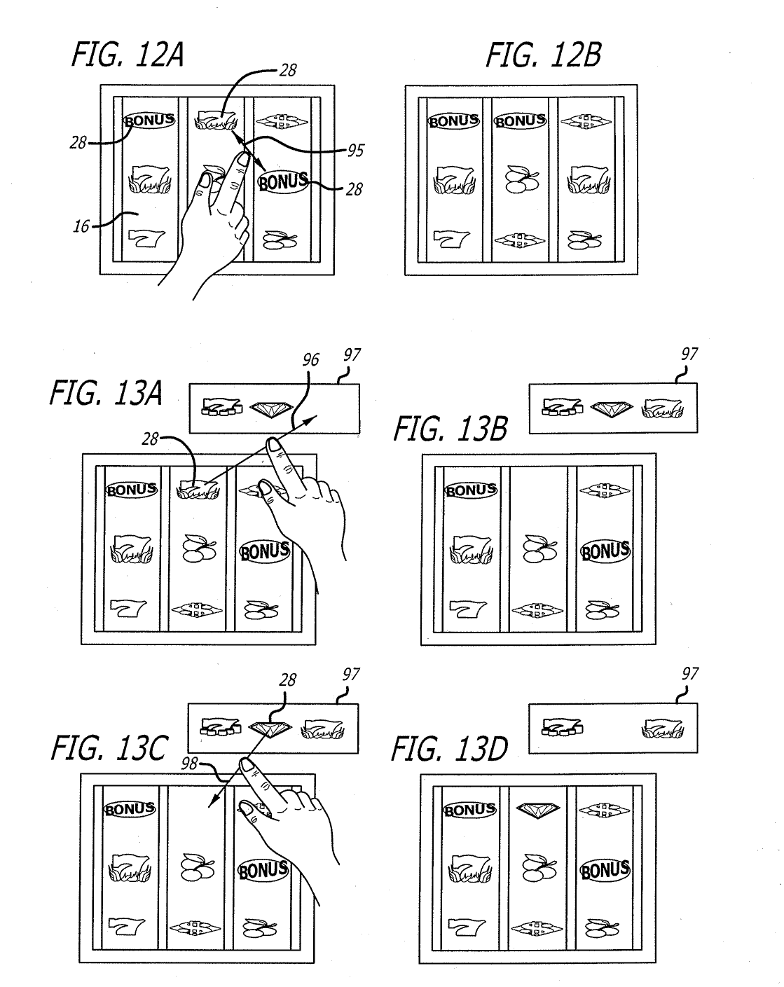

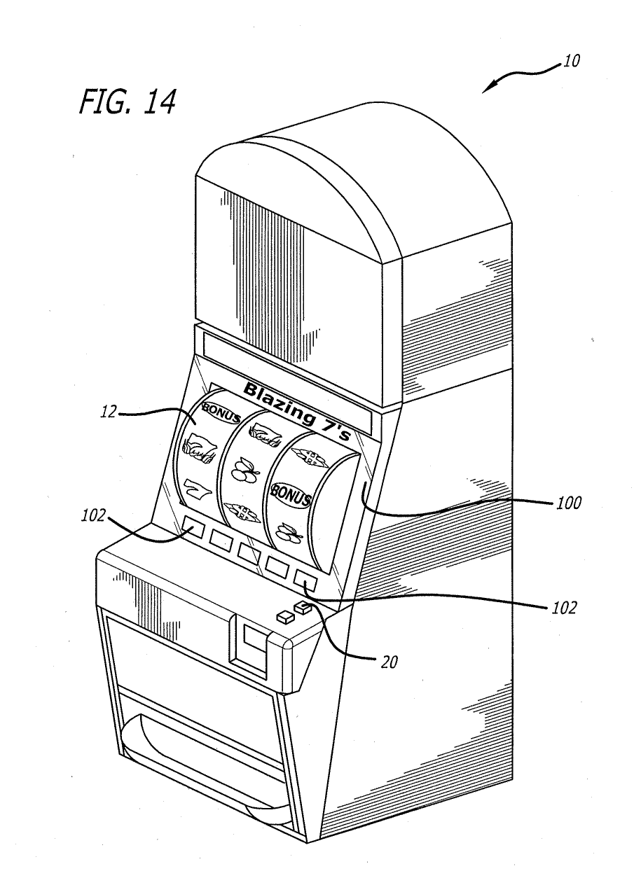

FIGS. 11A-11C illustrate various screen shots of touch gestures that add or remove reels from the game. A generally-perpendicular, touch gesture 93 in a direction away from the reels is interpreted as a player request to remove reels. FIG. 11A shows a five-reel game and a player touch gesture 93 (away from the reels toward the edge of the screen). As a result, two reels are removed from the game, and the curved display projects an image of a three-reel game as shown in FIG. 11B. According to one embodiment, each generally perpendicular touch gesture in a direction away from the reels causes one reel to be removed. In another embodiment, each generally perpendicular touch gesture causes a predetermined number of reels (e.g., two reels) to be removed from the game. As those skilled in the art will appreciate, the game is configured to have a predetermined minimum number of reels for a particular game.

As shown in FIG. 11B, a generally-perpendicular touch gesture 94 from the edge/side of the curved display toward the center of the display causes one or more reels to be added to the game. As shown in FIG. 11C, the touch gesture 94 of FIG. 11B causes one reel to be added to the game to form a four-reel game. A gesture 93, 94 may be programmed to add one reel or add a predefined group of reels (e.g., two, three, or more reels per gesture).

FIGS. 12A-12B illustrate another embodiment of touch gestures 95 that allow a player to move symbols 28 between reels 16. As shown in FIG. 12A, the gesture is touching the positions on the touch screen corresponding to two game indicia (e.g., with the thumb and middle finger) and drawing the thumb and middle finger together. This gesture will cause two symbols to swap positions on the reels as shown in FIG. 12B.

As shown in FIGS. 12A-12B, a player is able to swap symbols between adjacent reels. Alternatively, the player may be able to swap symbols between non-adjacent reels. In another embodiment, the touch data may be a gesture that allows a player to change the order of symbols on the same reel. In one embodiment, only adjacent symbols on the same reel may be swapped. Alternatively, any symbols on the same reel may be swapped. The touch screen may be activated during certain portions of a game to allow a player to swap symbols. For example, the touch screen may be activated for a predetermined period of time after a game has completed. Accordingly, a player may attempt to achieve a winning outcome or improve a winning outcome by swapping symbols.

In various embodiments, the ability to swap symbols may be a feature of the game or the player must have satisfied some predefined criteria to permit this feature of the game. For example, the predefined criteria may be one or more maximum wagers, a predefined period of continuous play, a particular player club level, accrual of a particular number of player club points, or any other trigger events known or developed in the art. As those skilled in the art will appreciate, the game may be limited to only allow the player to swap certain game indicia. Alternatively, the game may allow any swapping of game indicia between reels or on the same reel. Optionally, the game may allow more than one swap per game.

In yet another embodiment, the touch screen is configured to accept touch data that allows a player to add a game indicia onto one or more reels or remove one or more indicia from a reel as shown in FIGS. 13A-13D. FIG. 13A illustrates one embodiment in which a touch gesture 96 from a game indicia 28 on one of the reels to a symbol bank 97 causes the game indicia to be moved from the reel to the symbol bank as shown in FIG. 13B. FIG. 13C illustrates one embodiment in which a touch gesture 98 from a symbol bank 97 to a reel 16 causes a game indicia 28 to be added to a reel at the position in which the touch gesture terminates, as shown in FIG. 13D. In another embodiment, the game indicia may be randomly added to a reel. Generally, the game indicia is added or removed prior to game play or after a game has ended. Optionally, the game indicia may be added while the reels are spinning. The touch screen may be activated to allow such gestures in response to a wager, game outcome, some player characteristic, or a trigger event.

In another embodiment, the touch screen is configured to accept touch data that allows a player to define a pay line. Accordingly, a player may drag a finger across the screen to connect a number of positions on one or more reels to form a pay line. For example, in a three-reel game having three pay lines (i.e., display shows three symbols on each reel), the player may define a pay line that is composed of two symbol positions on the first reel and one symbol position on the second reel. These symbol positions are generally composed of three adjacent symbol positions. Alternatively, the pay line is composed of three non-adjacent symbol positions. In another embodiment, the pay line may be composed of merely three symbol positions on any number of the reels. As those skilled in the art will appreciate, a five-reel game having a touch screen may allow a player-defined pay lines.

FIG. 14 illustrates another embodiment of a gaming device 10 having a curved display 12 and a LCD 100. Generally, the LCD 100 is a flat panel display, but the LCD may be curved (e.g., concave, convex, or a combination thereof). As shown in FIG. 14, the LCD 100 includes an opening sized to allow at least a portion of the curved display 12 to protrude through the opening. As shown in FIG. 14, the entire curved display 12 is protruding through the opening of the LCD 100. In another embodiment, the opening of the LCD 100 is sized to allow only a portion of the curved display 12 to protrude through the opening. In yet another embodiment, the curved display 12 is positioned behind the opening of the LCD 100.

The LCD 100 may present gaming and non-gaming related information. The gaming information may include, but is not limited to, available credits, credits wagered, credits wagered per pay line, active pay lines, win meter, wager denomination, indicia representing selected pay lines, maximum bet amount, amount wagered, or any combination thereof. Other gaming information includes, but is not limited to, game instructions one or more help menus, one or more pay tables, jackpot or progressive jackpot or game information, tournament game information, community gaming information, notification of a bonus game, number of bonus points, animation, images (e.g., still or video), or other features related to game play or the game theme.

In addition to gaming information, the LCD 100 may present non-gaming information during or prior to the game (e.g., during an attract mode). The LCD 100 may present either still images, video images, or graphics related to the game title or game theme. Optionally, the LCD 100 may present information not related to the game such as, but not limited to, player tracking account information, advertisements, a news ticker, sports ticker, safety information (e.g., warnings regarding responsible gaming, fire alarms, or the like), or status of a drink and/or food order.

In yet another embodiment, the LCD 100 may present a player interface having one or more images of buttons 102. The buttons 102 may be related to game play (e.g., spin reels or activate a bonus game) or wagering activities such as, but not limited to, selecting a wager denomination, selecting a wager amount, placing a maximum bet, placing a minimum bet, or cashing out remaining credits.

In another embodiment, the LCD 100 of FIG. 14 is substituted with a display screen having a similar shape (i.e., display with an opening). Alternatively, the curved display and the display screen are integral. The display screen may present both gaming and non-gaming information. This information is presented on the display screen using a DLP device. In one embodiment, a single DLP device is used to present the information on the display screen and the game on the curved display. Alternatively, one or more DLP devices may be is used to present the information on the display screen and the curved display 12.

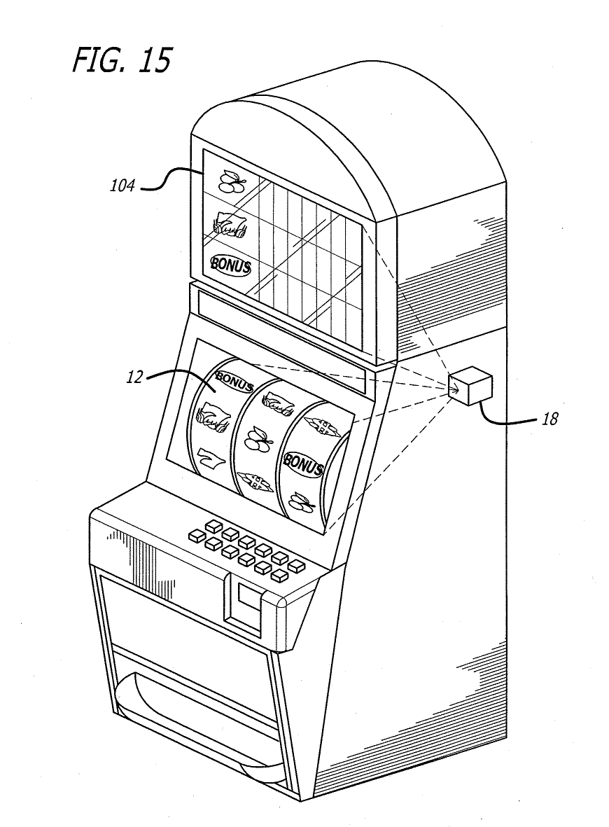

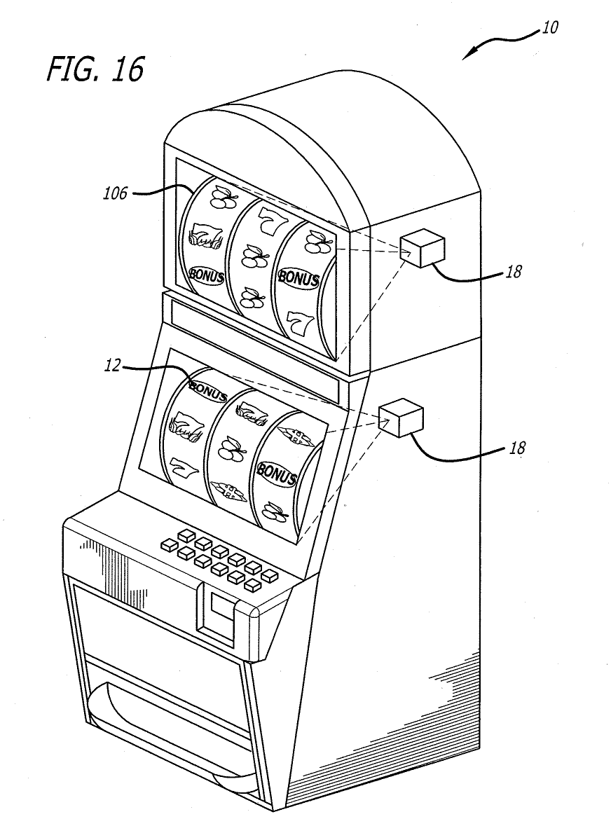

FIG. 15 illustrates one embodiment of a gaming machine 10 having a curved display 12 and a secondary display screen 104 positioned above the curved display. In one embodiment, the secondary display screen 104 is a LCD, plasma, CRT, or other display device such as, but not limited to, one or more reels or wheels. In another embodiment, the secondary display 104 is a DLP display screen. In one embodiment, a single DLP device is used to project images on the curved display and the secondary display, as shown in FIG. 15. Alternatively, the curved display 12 and the secondary display 104 have dedicated DLP devices.

FIG. 16 illustrates another embodiment of a gaming machine 10 having a curved display 12 that is used both a primary display and a secondary display 106. In one embodiment, a single DLP device is used to project still and video images onto both the curved display 12 and the secondary display 106. As shown in FIG. 16, each curved display 12, 106 has a dedicated DLP device.

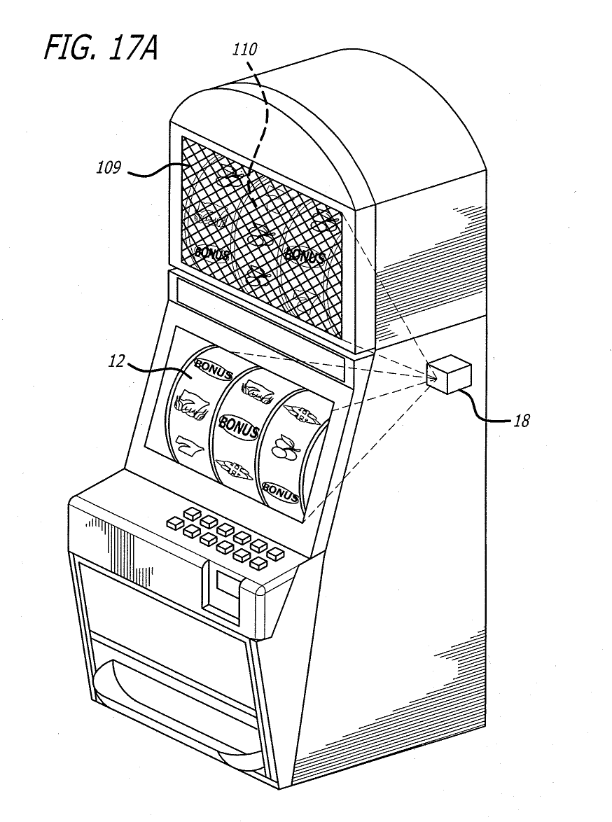

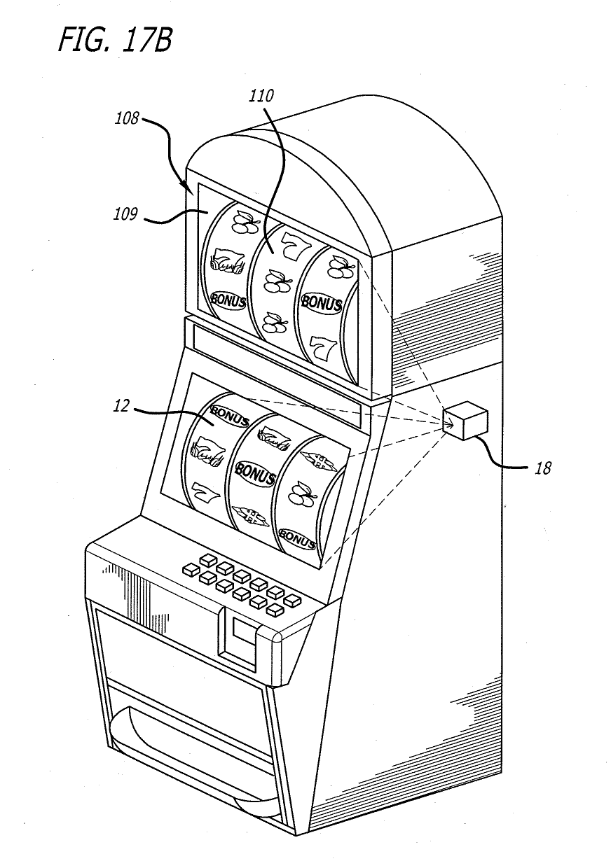

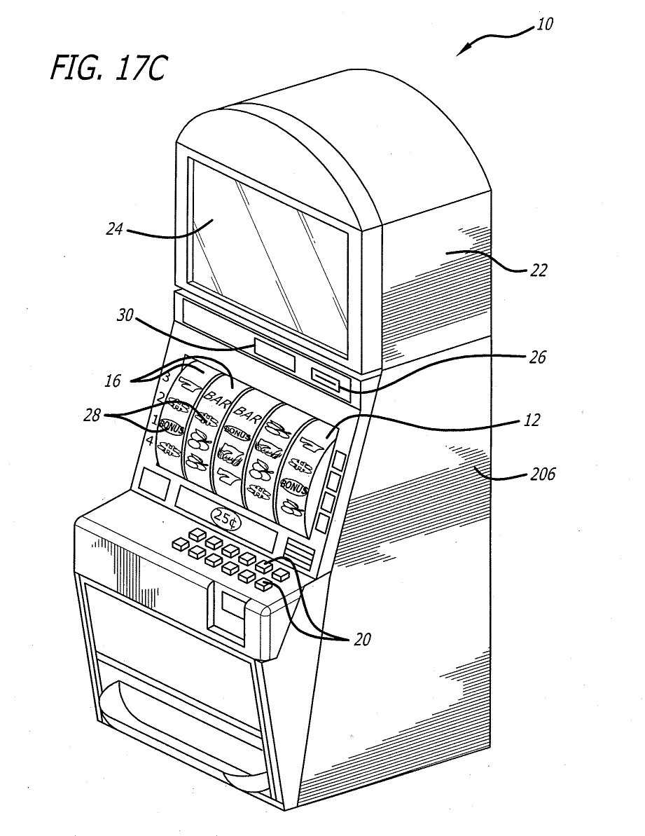

FIGS. 17A-17B illustrate another embodiment of a gaming machine having a curved display 12 and a secondary display 108. The secondary display 108 is composed of a LCD 109 that is placed in front of a secondary curved display 110. As shown in FIG. 17A, the LCD 109 obscures the secondary curved display 110. The LCD 109 may present a bonus game, game-related information, or non-game related information. As shown in FIG. 17B, the LCD 109 is transmissive such that the secondary curved display 110 is visible to the game patron. In some embodiments, the polarizers associated with the LCD 109 may be removed from the LCD as some LED projectors are not powerful enough to overcome the polarizers in the LCD.

FIG. 17C illustrates another embodiment of a gaming machine having a molded main display. The molded main display has a curved main portion 15 and flat surfaces 17 positioned around the perimeter of the curved main portion. The flat surfaces 17 present game information such as, but not limited to, payline information (e.g., active/inactive paylines, wager per payline, payline number), game instructions, possible wager denominations, selected wager denomination, total credits won, total credits wagered, credits remaining, graphics, game title banners, images and/or video clips related to the game and/or game theme, or any combination thereof. In this embodiment, a single DLP device 18 projects the game onto the curved screen 15 and the game information onto the flat surfaces 17.

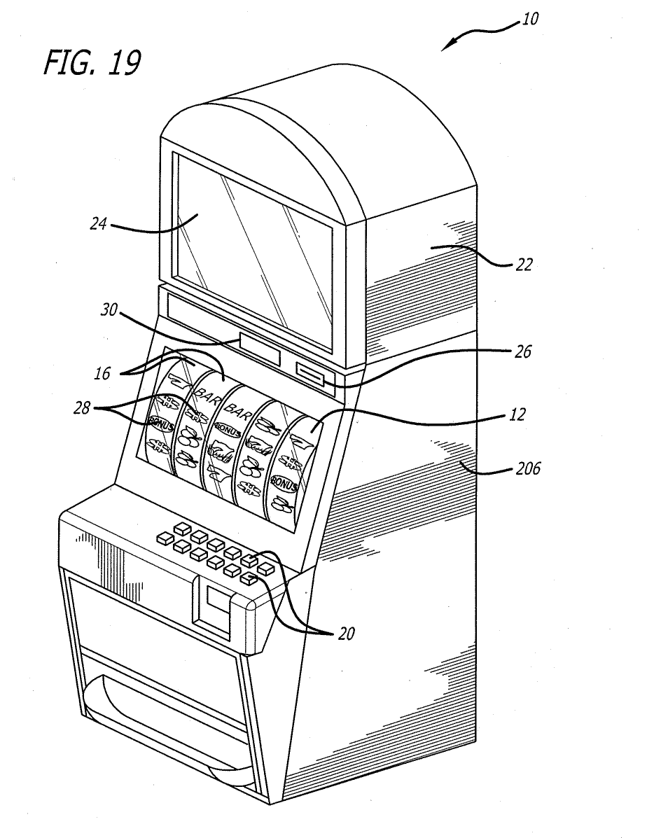

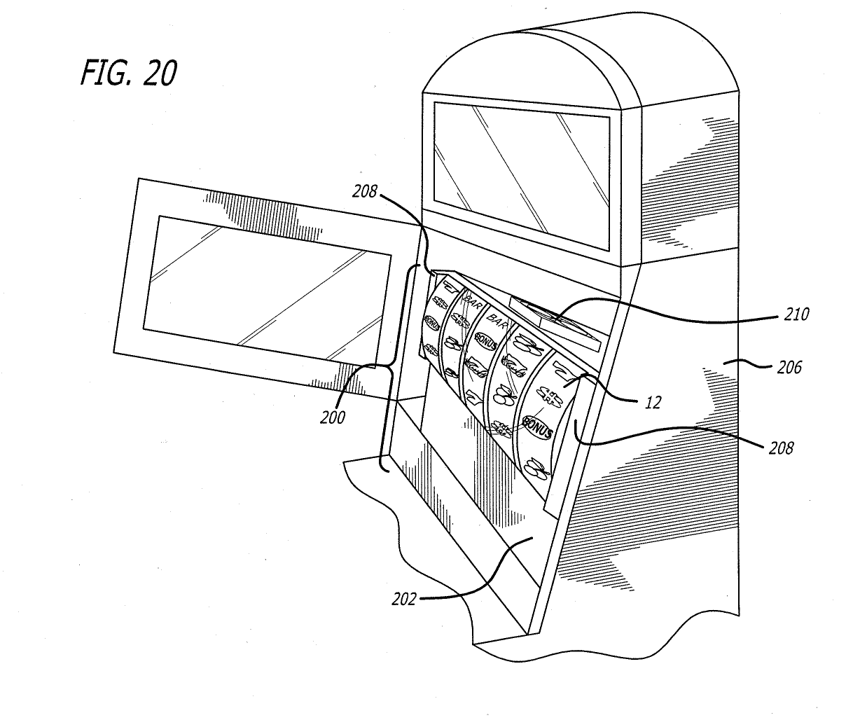

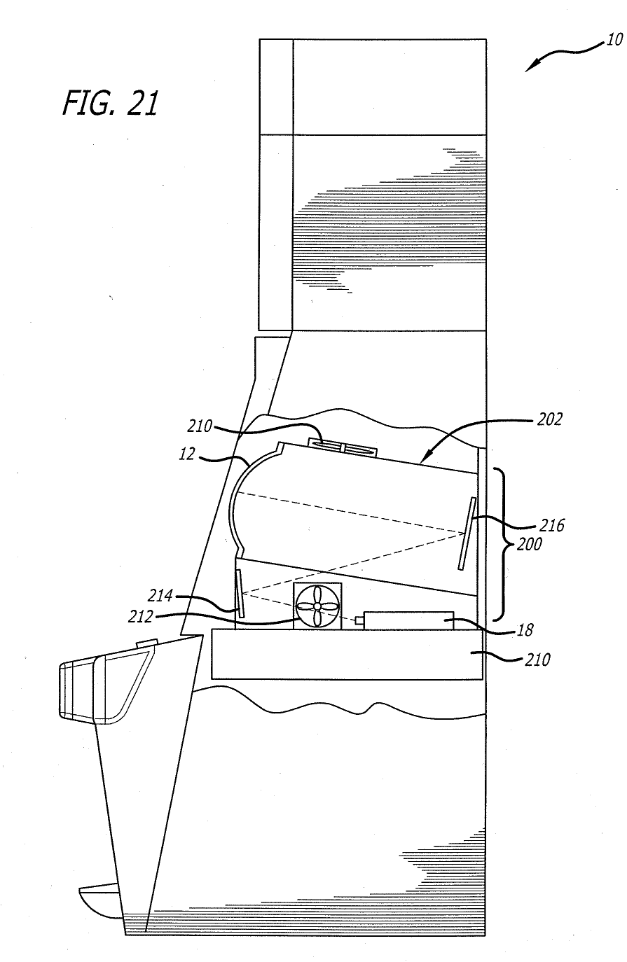

FIGS. 19-21 illustrate one embodiment of a self-contained projection system 200 that includes a curved display 12 and the associated projection components. The self-contained projection system 200 includes an enclosure 202 that is sealed to prevent dirt, dust and debris from contaminating the interior of the enclosure because any contaminants will adversely affect the light path (i.e., the path of light from the projector lens to the mirrors and to the curved material). The enclosure 202 may have one more walls 204 in combination with the curved material 12 to provide a sealed housing. As shown in FIGS. 20-21, the curved material 12 is coupled to the front of the enclosure 202. The interior of the enclosure 202 of the projection system 200 may include a light absorbing coating to absorb any stray or additional light rays from the projection source. The light absorbing coating may be, for example, black paint, powder coating, or a black texture coat.

Optionally, an aperture (not shown) may also be positioned in front of the projection source (or within the lens of the projection source) to reduce any stray light from reflecting within the enclosure. The aperture may be flat material having one or more openings corresponding to the images being projected onto the curved display.

The self-contained projection system 200 is mounted within a gaming cabinet comprising 206 brackets 208 provided on the sides of the enclosure 202, as shown in FIG. 20. The brackets 208 include openings and/or recesses for coupling the bracket to the sides of the gaming cabinet 206. The inner surface of the brackets 208 also includes a recessed curved groove (not shown) sized and shaped to accommodate the curved material 12. In another embodiment, the enclosure 202 is positioned on top of a shelf 210 or other horizontal platform provided within the cabinet. In yet another embodiment, the self-contained system 200 is coupled to the sides of the gaming cabinet 206 and rests on a platform 210, as shown in FIG. 21. Optionally, one or more shock absorbers (e.g., bushings, gaskets, springs) may be placed between the self-contained system 200 and the gaming cabinet to isolate the system from any jarring forces or shock impulses.

Because the self-contained projection system 200 is sealed, one or more fans or heat pumps are provided to remove heat from the enclosure 202. For example, a fan 210 is provided at the top of the enclosure 202, and a fan 212 is provided near the DLP projector as shown in FIG. 21.

In FIG. 21, a DLP projector 18 is placed at the base of the enclosure 202. A cradle (not shown) fixes the DLP device 18 to the base of the enclosure 202 in order to ensure proper calibration of the projection system. The cradle (not shown) may be one or more brackets, jigs, and/or mounts cast, molded, or bolted to the base of the enclosure.

As shown in FIG. 21, a mirror 214 is placed at the front of the enclosure 202 near the base of the enclosure, and another mirror 216 is placed at the back of the enclosure 202 near the top of the enclosure. The mirrors 214, 216 are front glass mirrors or any other mirrors known or developed in the art that substantially reflects the image projected onto the mirror. The mirrors 214, 216 are substantially flat and generally rectangular in shape. According to one embodiment, the lower mirror 214 is smaller in size as compared to the upper mirror 216.

The lower mirror 214 is angled such that the bottom of the mirror is further away from the front of the enclosure 202 as compared to the top of the mirror. Similarly, the upper mirror 216 is angled so that the bottom of the mirror is closer to the front of the enclosure as compared to the top of the mirror. That is, the lower and upper mirrors 214, 216 are angled to reflect the projected image upwards and ultimately to the curved material 12. The mirrors 214, 216 reduce the overall depth of the enclosure 202 by dividing the light path. In other embodiments, the mirrors may be angled in any direction or at any angle to ensure that the projected image is reflected onto the curved material.

In one embodiment, the mirrors 214, 216 are attached to a hinge (not shown) in order to adjust the angle of the mirrors. In another embodiment, a remotely controlled motor (not shown) is coupled to the mirrors 214, 216 by a force transmission member (not shown) in order to adjust the angle of the mirrors 214, 216. In yet another embodiment, one or more shims are used to adjust and fix the position of the mirrors. In another embodiment, the lower mirror 214 is adjustable and the upper mirror 216 is mounted at a fixed angle. Alternatively, the lower mirror 214 is fixed and the upper mirror 216 is adjustable. Optionally, the angle of the mirrors 214, 216 may also be adjusted by a laser alignment process. A laser is used during the assembly process to ensure that the optical path is properly aligned and calibrated.

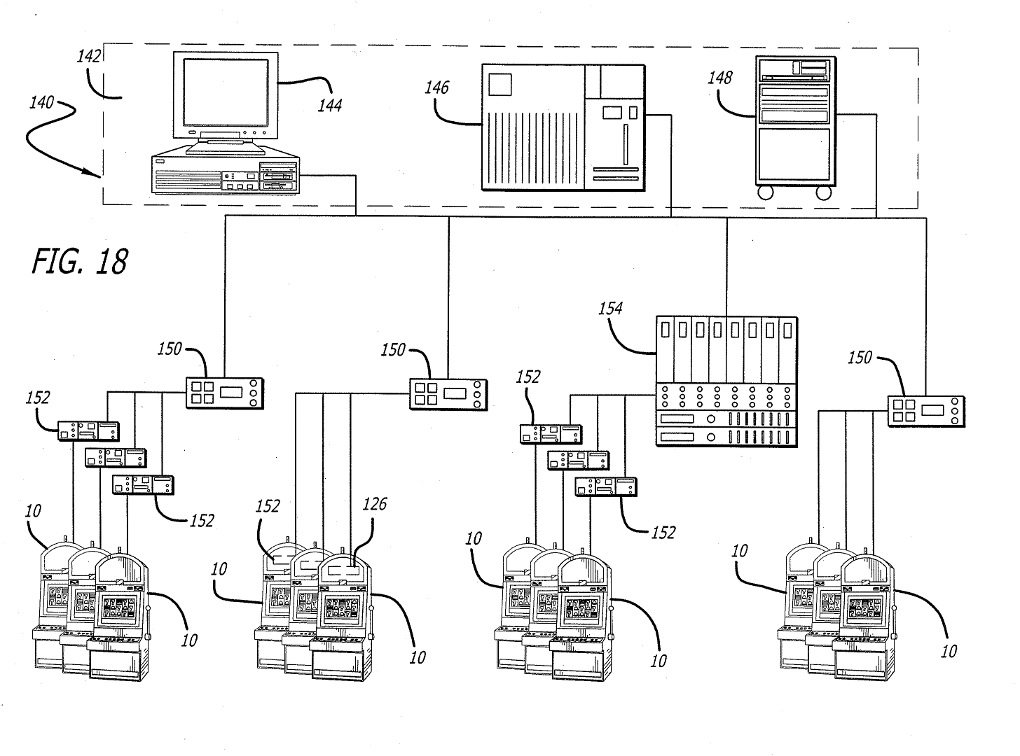

FIG. 18 illustrates a casino gaming system that may include one or more gaming machines 10 that have a curved display. The casino gaming system 140 comprises one or more gaming machines 10. The gaming machines 10 illustrated in FIG. 18 act as terminals for interacting with a player playing a casino game. Networking components facilitate communications between the system server 142 and game management units 152 that control displays for carousels of gaming machines 10 across a network. Game management units (GMU's) 152 connect gaming machines to networking components and may be installed in the gaming machine cabinet or external to the gaming machine 10. The function of the GMU 152 is similar to the function of a network interface card connected to a desktop personal computer (PC). Some GMU's 152 have much greater capability and can perform such tasks as presenting and playing a game using a display (not shown) operatively connected to the GMU 152. In one embodiment, the GMU 152 is a separate component located outside the gaming machine 10. Alternatively, in another embodiment, the GMU 152 is located within the gaming machine 10. Optionally, in an alternative embodiment, one or more gaming machines 10 connect directly to a network and are not connected to a GMU 152.

The gaming machines 10 are connected via a network to a network bridge 150, which is used for networking, routing and polling gaming machines, including slot machines. The network bridge 150 connects to a back end system 142. Optionally, the gaming machines 10 may connect to the network via a network rack 142, which provides for a few numbers of connections to the back end system 142. Both, network bridge 150 and network rack 154 may be classified as middleware, and facilitate communications between the back end system 142 and the game management units 152. The network bridges 150 and network rack 154 may comprise data repositories for storing network performance data. Such performance data may be based on network traffic and other network related information. Optionally, the network bridge 150 and the network rack 154 may be interchangeable components. For example, in one embodiment, a casino gaming system may comprise only network bridges and no network racks. Alternatively, in another embodiment, a casino gaming system may comprise only network racks and no network bridges. Additionally, in an alternative embodiment, a casino gaming system may comprise any combination of one or more network bridges and one or more network racks.

The back end system 142 may be configured to comprise one or more servers. The type of server employed is generally determined by the platform and software requirements of the gaming system. In one embodiment, as illustrated in FIG. 18, the back end system 142 is configured to include three servers: a slot floor controller 144, a casino management server 146 and a casino database 148. The slot floor controller 144 is a part of the player tracking system for gathering accounting, security and player specific information. The casino management server 146 and casino database 148 work together to store and process information specific to both employees and players. Player specific information includes, but is not limited to, passwords, biometric identification, player card identification, and biographic data. Additionally, employee specification information may include biographic data, biometric information, job level and rank, passwords, authorization codes and security clearance levels.

Overall, the back end system 142 performs several functions. For example, the back end system 142 can collect data from the slot floor as communicated to it from other network components, and maintain the collected data in its database. The back end system 142 may use slot floor data to generate a report used in casino operation functions. Examples of such reports include, but are not limited to, accounting reports, security reports, and usage reports. The back end system 142 may also pass data to another server for other functions. Alternatively, the back end system 142 may pass data stored on its database to floor hardware for interaction with a game or game player. For example, data such as a game player's name or the amount of a ticket being redeemed at a game may be passed to the floor hardware. Additionally, the back end system 142 may comprise one or more data repositories for storing data. Examples of types of data stored in the system server data repositories include, but are not limited to, information relating to individual player play data, individual game accounting data, gaming machine accounting data, cashable ticket data, sound data, and optimal display configurations for one or more displays for one or more system game.

Of course, one will appreciate that a gaming system 140 may also comprise other types of components, and the above illustrations are meant only as examples and not as limitations to the types of components or games used in a casino gaming system.

Referring back to FIG. 1, the gaming machine 10 includes a plurality of player-activated buttons 20 used for various functions such as, but not limited to, selecting a wager denomination, selecting a number of games to be played, selecting the wager amount per game, initiating a game, or cashing out money from the gaming machine 10. In various embodiments, the player-activated buttons 20 functions are, but are not limited to, mechanical buttons, electromechanical buttons, touch screen buttons, or soft key buttons. According to one embodiment, the buttons 20 are backlit to indicate whether the button is active.

In another embodiment, the player-activated button is a universal button module that provides a dynamic button system adaptable for use with various games, as disclosed in U.S. application Ser. No. 11/106,212, entitled “Universal Button Module”, filed Apr. 14, 2005 and U.S. application Ser. No. 11/223,364, entitled “Universal Button Module”, filed Sep. 9, 2005, which are both hereby incorporated herein by reference. In other embodiments, other input devices, such as but not limited to, touch pad, track ball, mouse, switches, and toggle switches, are included with the gaming machine to also accept player input.

In yet another embodiment, a cellular phone or other input device (e.g., PDA), separate and apart, from the gaming machine 10 may also be used to input various player choices and information to enhance the player's interactive experience with the gaming machine. In this embodiment, the gaming machine 10 includes an IR sensor, RF sensor, BLUETOOTH receiver, or other means for receiving input from a cellular phone or other wireless input devices. Furthermore, inputting information via these devices provides an added level of security as any key presses may be hidden from view. In yet another embodiment, a player may call or send a text message or a short message service (SMS) to the gaming machine 10.

The main cabinet 14 of the gaming machine 10 is a self-standing unit that is generally rectangular in shape. In another embodiment, the main cabinet is a slant-top gaming cabinet. Alternatively, in other embodiments, the gaming cabinet may be any shaped cabinet known or developed in the art that may include a top box. Additionally, the cabinet may be manufactured with reinforced steel or other rigid materials that are resistant to tampering and vandalism. Optionally, in an alternate embodiment, the gaming machine is a cinema-style gaming machine (not shown) having a widescreen display, as disclosed in U.S. application Ser. No. 11/225,827, entitled “Ergonomic Gaming Cabinet,” filed on Sep. 12, 2005, which is hereby incorporated herein by reference.

As shown in FIG. 1, the gaming machine 10 includes a top box 22 and a main cabinet 16. According to one embodiment, the top box 22 is a separate and distinct component that is affixed to the main cabinet 14. In another embodiment, the top box 22 is an area that is partitioned from the main cabinet 14. Alternatively, the top box 22 and the main cabinet 14 may be contiguous areas with the outward appearance of two distinct components. In another embodiment, the top box 22 also includes a display glass (not shown) that includes the name of the game, artwork, game instructions, pay table, or other information relating to one or more games presented on the gaming machine 10.

In another embodiment, the top box 18 includes a secondary display 24. The secondary display 24 presents game information (e.g., name of the game, animation, one or more pay tables, game information, one or more help menus, progressive jackpot or game information, tournament game information, or any combination thereof) or non-game related information (e.g., news, advertisements, messages, promotions, or any combination thereof). In another embodiment, the secondary display 24 presents a secondary game such as, but not limited to, a bonus game, a progressive game, or another game of chance such as, but not limited to, video slots, video keno, video poker, video blackjack, video roulette, Class II bingo, games of skill, games of chance involving some player skill, or any combination thereof.

In an alternative embodiment, the secondary display 24 presents game-related information such as, but not limited to, a pay table or one or more game options to the player. Alternately, the secondary display 24 presents non-game related information such as, but not limited to, advertisements, news, information on sports betting and betting options for those sporting events, requests for drinks or food, concierge services, or promotional information (e.g., information relating to player's club).

Optionally, the gaming machine 10 also includes a third display 30 positioned above the curved material 12. As those skilled in the art will appreciate, the third display may be positioned below the main display, adjacent to the primary or secondary display, on the player interface, or any location on the gaming machine within the line-of-sight of a player. According to one embodiment, the third display 30 is a graphical interface, which is the subject of U.S. patent application Ser. No. 10/943,771, filed Sep. 16, 2004, which is hereby incorporated herein by reference.

The graphical interface includes a web content capable display screen and an embedded processor. Preferably, the web content capable display screen presents web information to a user via the display screen. The embedded processor preferably utilizes an internal operating system and communicates with the gaming processor of the gaming machine. Preferably, the embedded processor reads incoming data, translates the data into a web protocol (web authoring language), if necessary, and maps the data to the web content capable display screen. In this manner, the web content capable display screen increases user excitement by providing a richer gaming experience. Furthermore, the display allows the player to play a secondary game, input information, make selections, receive promotional information or other types of information including, but not limited to, notification that the player has won a system award, is entered into a tournament game or other bonus game. Additionally, the player is able to configure the attributes of interchanging display content via the graphical interface. In another embodiment, the content of the graphical interface may be presented on a portion of the main display 12 or as a pop-up window on the main display.

As shown in FIG. 1, the gaming machine 10 includes a player tracking system. The player tracking system allows a casino to monitor the gaming activities of various players. Additionally, the player tracking system is able to store data relating to a player's gaming habits. That is, a player can accrue player points that depend upon the amount and frequency of their wagers. Casinos can use these player points to compensate the loyal patronage of players. For example, casinos may award or “comp” a player free meals, room accommodations, tickets to shows, and invitations to casino events and promotional affairs. In one embodiment, the player's club level (e.g., Silver, Gold, Platinum), player rating, or total number of player points may qualify a player for a keno bonus round. In another embodiment, the player's club level adjusts the pay table for a keno game. Accordingly, a higher rated player wins more money for a given outcome as compared to a lower level (or unrated) player.

Typically, the player tracking system is operatively connected to one or more input components on the gaming machine 10. These input components include, but are not limited to, a slot 26 for receiving a player tracking card, a keypad or equivalent, an electronic button receptor, a display, a touch screen, or the like. The player tracking system may also include a database of all qualified players (i.e., those players who have enrolled in a player rating or point accruing program). Generally, the database for the player tracking system is separate from the gaming machines.

The main cabinet 14 of the gaming machine also houses a game management unit (not shown) that includes a CPU, circuitry, and software for receiving signals from the player-activated buttons 20, operating the games, and transmitting signals to the respective game display 12, 24 and speakers.

In various embodiments, game program may be stored in a memory (not shown) comprising a read only memory (ROM), volatile or non-volatile random access memory (RAM), a hard drive or flash memory device or any of several alternative types of single or multiple memory devices or structures. Optionally, the gaming machine 10 includes one or more data repositories for storing data. Examples of information stored by the gaming machines 10 include, but are not limited to, accounting data, maintenance history information, short and/or long-term play data, real-time play data, sound data, video data, or animation data.

As shown in FIG. 1, the gaming machine 10 includes a ticket reader/ticket printer slot 36 that is associated with a cashless gaming system (not shown). According to one embodiment, the slot 36 is used for the ticket reader and ticket printer. Accordingly, the same slot 36 may be used to insert and/or issue a ticket. However, in alternate embodiments, separate slots (not shown) may be provided for the ticket acceptor and the ticket printer. In one embodiment, the ticket reader (not shown) of the cashless gaming system is capable of accepting previously printed vouchers, paper currency, promotional coupons, or the like. The ticket printer (not shown) of the cashless gaming system generates vouchers having printed information that includes, but is not limited to, the value of the voucher (i.e., cash-out amount) and a barcode that identifies the voucher.

In another embodiment, the gaming machine 10 includes an internet connection or other known network connections to link one or more gaming machines together. According to one embodiment, the internet connection is used for web browsing, prize redemption, or access to other gaming or non-gaming information. Additionally, with the various gaming machines in communication with one another (or a system host), the gaming machine 10 may participate in a gaming tournament. In one embodiment, the gaming tournament is a competitive gaming tournament having one or more winners. Alternatively, the gaming tournament is a cooperative gaming tournament where all eligible gaming machines win a particular award.

Other various embodiments are directed to using a Video Switcher and Touch Router Device (sometimes referred to herein as a “Display Manager”), to enable system menus and other Picture-in-Picture applications to overlay the wagering game on the curved material 12. Other embodiments may include sharing the primary curved DLP display 12 between one or more wagering games and one or more system marketing promotions, e.g., advertising, loyalty, customer-centric messages, video conferencing, and video-on-demand applications. Generally, the terms “mixing” and “re-rendering” (e.g., switching, arbitrating, redistributing, routing, or the like), and other forms of each, refer to original signals being passed through a switching device without any copying and/or saving of the signals or associated data. However, it will be appreciated by those skilled in the art that other embodiments may use any form of video signal processing herein. A video switcher and touch router system for a gaming machine is shown and described in U.S. application Ser. Nos. 12/350,938 and 12/350,939, which are both incorporated by reference herein.

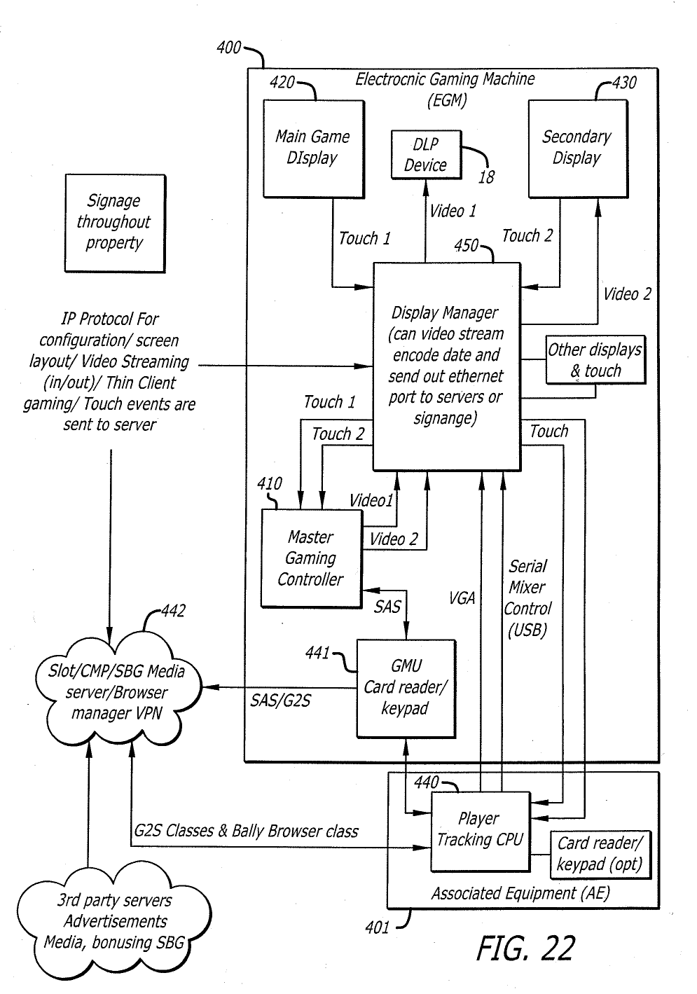

Referring to FIG. 22, a component diagram depicts a Display Manager 450 (i.e., Video Switcher/Touch Router Device) connected to main components of a gaming machine 400 and associated equipment. In one embodiment, the Display Manager 450 receives one or more video signals from a Master Gaming Controller 410 and Player Tracking Unit 440. The Display Manager 450 receives touch signals from touch screen controllers on a Main Game Display 420 and a Secondary Display 430, and routes the signals to the Master Gaming Controller 410 or Player Tracking Unit 440. In one embodiment, the Player Tracking Unit 440 communicates with the Master Gaming Controller 410 through a Game Monitoring Unit (GMU) 441. The GMU 441 provides a communication interface between the Master Gaming Controller 410 and a Slot Virtual Private Network to handle such things as slot accounting, and the like. In this embodiment, the Main Game Display 420 includes the curved display system 50 and the touch screen system 54, as described above. Accordingly, it is the touch signals from the touch screen controllers of the touch screen system 54 that are received by the Display Manager.

The Display Manager 450 has the ability to build a video stream from the VGA signals from the Master Gaming Controller 410 and/or Player Tracking Unit 440. This video stream may be then sent over Ethernet to a server, another gaming device, or to overhead signage. This allows the game presentation to be sent enterprise-wide for broadcast purposes. A non-limiting example is that a jackpot win may have the game screens sent to overhead LCD signs throughout the casino and on web portals. This creates the excitement for all players and not just the one who triggered the progressive. Also the Display Manager 450 may receive a video stream from a server and blend this video stream into one or more Picture-In-Picture (“PIP”) window frames projected onto the curved material 12 by the DLP device or other light projection system. The PIP window frames may also be viewed on one or more LCD displays at the same time. Server executed games may be video streamed to this Display Manager 450 for presentation to the player. Player inputs from the button deck and touch screen may be sent to the Server-Based Game Engine (SBG) for processing. In some embodiments the Master Gaming Controller 410 is not needed to provide a thin-client gaming device. The only components needed are the Display Manager 450 and the peripheral controller. All RNG (Random Number Generator) game outcomes are determined and rendered on the servers. Even skill or skill predominate games may execute on the server and be presented to the user over this video stream.

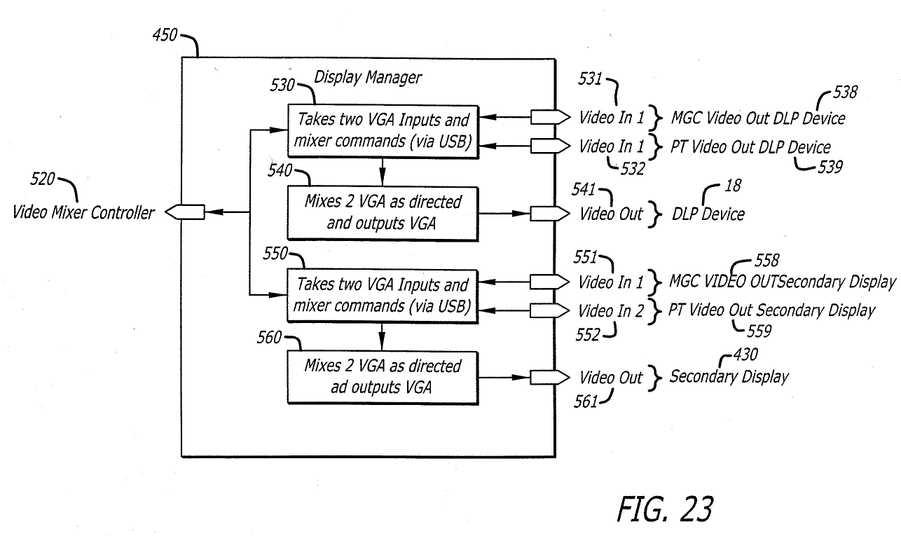

The component diagram of FIG. 23 depicts a Display Manager 450 used for switching video signals and outputting the result to the DLP device 18 of the curved display system 50 or Secondary Display 430. In a preferred embodiment, the Display Manager 450 has one or more video input ports 531 and 532 that receive video signals 530 intended for the DLP projector 18, from a Master Gaming Controller video output 538 and Player Tracking Unit video output 539. The Display Manager receives instructions through a Video Switcher Controller port 520. Using the video signals, the Display Manager 450 mixes 240 (e.g., switches, arbitrates, redistributes, or the like) the video signals as directed by the commands coming in from the Video Mixer Controller 520 and outputs the result through a video-out port 541 that is connected to the video-in port on the DLP device 18.

In another embodiment, the Display Manager 450 also has one or more video input ports 551 and 552 that receive video signals 550 intended for the Secondary Display 430 from a Master Gaming Controller video output 558 and Player Tracking Unit video output 559. The Display Manager 450 receives instructions through the Video Mixer Controller 520. Using the video signals, the Display Manager 450 mixes 260 (e.g., switches, arbitrates, redistributes, or the like) the video signals as directed by the commands coming in from the Video Mixer Controller 520 and outputs the result through the video-out port 561 that is connected to the video-in port on the Secondary Display 430.

In one embodiment, these video input and output connections 531, 532, 541, 551, 552, and 561 are 15-pin Super Video Graphics Array (“SVGA”). In an alternative embodiment, these video connections may be 9-pin Video Graphics Array (“VGA”), 15-pin SVGA, Low-voltage differential signalling (“LVDS”), Digital Visual Interface (“DVI”), any other video signal connection, or any combination thereof. The Master Gaming Controller 110 may be transmitting one or more protocols such as, but not limited to:

| | x | Y | Aspect |
|---|---|---|---|
| Name | (width) | (height) | Ratio |
| VGA | 640 | 480 | 4:3 |
| SVGA | 800 | 600 | 4:3 |
| XGA | 1024 | 768 | 4:3 |
| XGA+ | 1152 | 864 | 4:3 |
| SXGA | 1280 | 1024 | 5:4 |
| SXGA+ | 1400 | 1050 | 4:3 |
| UXGA | 1600 | 1200 | 4:3 |
| QXGA | 2048 | 1536 | 4:3 |
| WXGA* | 1366 | 768 | 16:9 |
| WXGA+* | 1440 | 900 | 16:10 |
| WSXGA* | 1600 | 1024 | 16:10 |
| WSXGA+ | 1680 | 1050 | 16:10 |
| WUXGA | 1920 | 1200 | 16:10 |
| WQXGA | 2560 | 1600 | 16:10 |

In one embodiment, the Video Mixer Controller 520 is a USB port. In an alternative embodiment, the port may be an RS-232 serial port or Ethernet port and connected to a server or other controller inside the gaming cabinet.

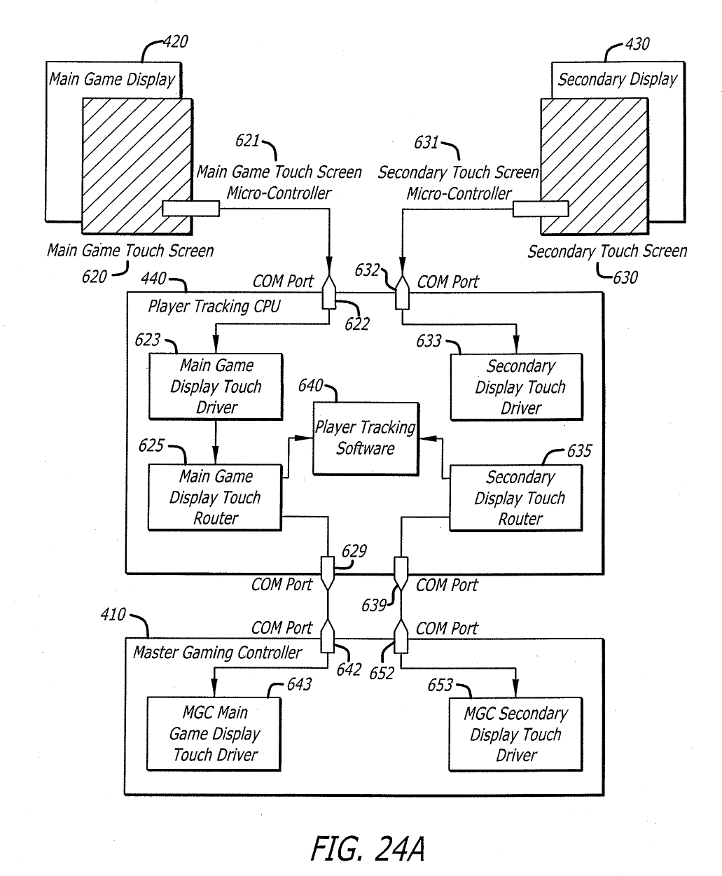

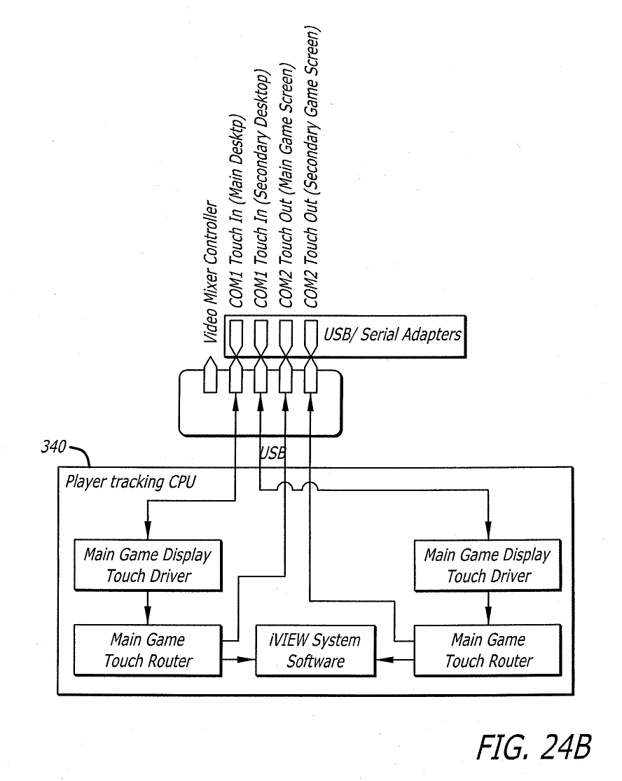

Referring now to FIG. 24A, Touch Routers 625 and 635 are shown receiving touch signals from touch controllers 621 and 631 and routing the signals to the appropriate software applications. In one embodiment, the Touch Routers 625 and 635 are executed on the Player Tracking Unit 440. In this embodiment, the Main Game Display 420 includes the curved display system 50 and a Main Game Touch Screen 620 (touch screen 54) placed in front of the curved display 12 of the curved display system. The Main Game Touch Screen is connected to the Main Game Touch Screen micro-controller 621. The micro-controller registers the touches by sending signals and commands to the Main Game Display Touch Driver 623 on the Player Tracking Unit 440. The micro-controller is connected to the Player Tracking Unit 440 via a COM port 622.

The Main Game Display Touch Driver 623 receives the micro-controller messages and commands and calculates the pixel coordinate of the touch and communicates these coordinates to the Main Game Display Touch Router 625. The Main Game Display Touch Router 625 determines if the touch occurred over the scaled and shifted video input from the Master Gaming Controller video input 531 or the Player Tracking Unit video input 532 to determine the proper destination to route the touch message. The touch message is either routed to the Player Tracking Software 640 or to the Main Game Display Touch Driver 643 on the Master Gaming Controller 410. The Player Tracking Unit 440 connects to the touch driver via a COM Port-Out 629 on the Player Tracking Unit connected to a COM Port-In 642 on the Master Gaming Controller 410.

In another embodiment, the system created content is rendered in an overlay window that occludes main game content. The non-remapped or scaled touch screen input data may be sent to both the Master Gaming Controller and the player tracking software and to the servers for processing. Otherwise stated, all applications receive all touch events, and each application processes these events in their own ways.

In another embodiment, the Secondary Display 430 is fitted with a Secondary Touch Screen 630. The Secondary Touch Screen is connected to the Secondary Touch Screen micro-controller 631. The micro-controller registers the touches by sending signals and commands to a Secondary Display Touch Driver 633 on the Player Tracking Unit 440. The micro-controller is connected to the Player Tracking Unit 440 via a COM port 632. The Secondary Display Touch Driver 633 receives the micro-controller messages and commands and calculates the pixel coordinate of the touch and communicates these coordinates to a Secondary Display Touch Router 635. The Secondary Display Touch Router determines if the touch occurred over the scaled and shifted video input from the video input 551 or the Player Tracking Unit video input 552 to determine the proper destination to route the touch message. The touch message is either routed to the Player Tracking Software 640 or to the Secondary Display Touch Driver 653 on the Master Gaming Controller 410. The Player Tracking Unit 440 connects to the touch driver via a COM Port-Out 639 on the Player Tracking Unit connected to a COM Port-In 652 on the Master Gaming Controller 410.

In one embodiment, the COM ports 622, 629, and 642 may be RS-232 serial ports. An alternative embodiment may use a USB port. Still another embodiment may use a combination of USB and serial ports, using USB-to-serial converters to allow RS-232 communications through USB ports. Those skilled in the art will appreciate that other ports may also be used, such as Ethernet, TCP/IP, and parallel ports. Referring to FIG. 24B, an embodiment is shown that utilizes a USB hub.

In still another embodiment, the Main Game Touch Screen 620 and the Secondary Touch Screen 630 use Sound Acoustic Wave technology to calculate the location of the touch. Alternative non-limiting embodiments may incorporate touch screens utilizing Resistive, Capacitive, Infrared, Strain Gauge, Optical Imaging, Dispersive Signal Technology, Acoustic Pulse Recognition, Frustrated Total Internal Reflection technologies, any multi-touch capable display technology, or any combination thereof.

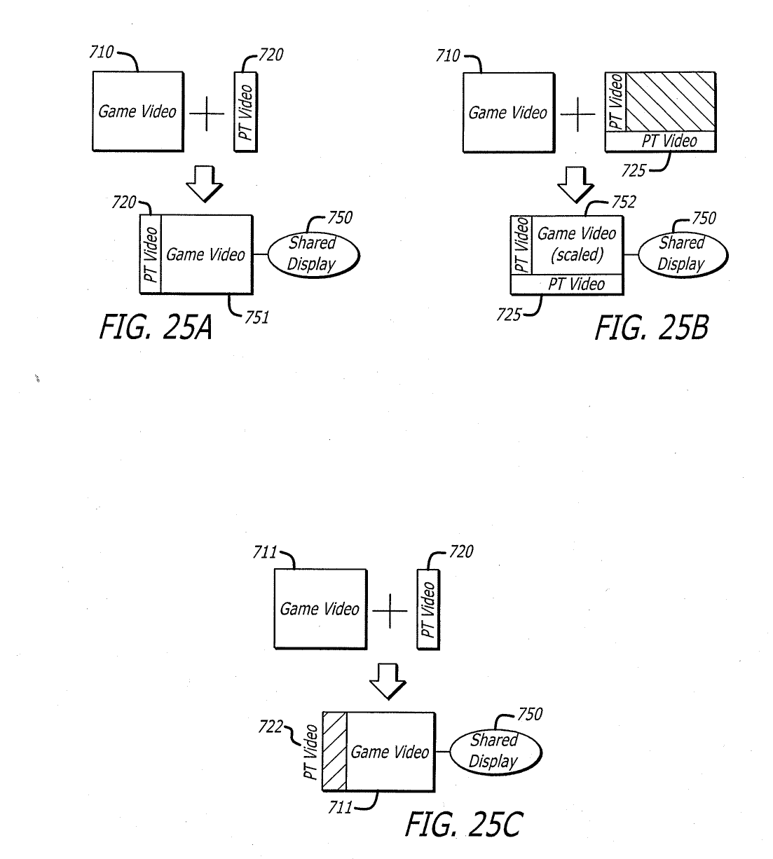

A series of diagrams are shown in FIGS. 25A through 25C demonstrating several methods of video switching of two video inputs 710 and 720 or 725, and displaying both simultaneously on a shared display 750. The shared display is of a combined video image projected onto the curved material 12 by the DLP device 18. FIG. 25A demonstrates a split screen scenario. In one embodiment, the Display Manager 450 receives the Game Video 710 and Player Tracking Unit Video 720 and displays them side-by-side on the curved material 12. In a non-limiting embodiment, the Player Tracking Unit Video 720 is not scaled or shifted, but a resulting Game Video 751 has been scaled horizontally so that both video signals are displayed on the shared display simultaneously. In another embodiment, the Player Tracking Unit Video is positioned towards the bottom of the display and scales the Game Video vertically. Still another embodiment scales both the Player Tracking Unit Video and the Game Video. Another alternate embodiment has a screen display that is larger and has a higher resolution than either the Game Display or Player Tracking Unit Display such that both video outputs may be displayed on a split screen without scaling either one.

Referring to FIG. 25B, a Picture-in-Picture scenario is demonstrated. In this embodiment, a screen layout of the Player Tracking Unit Video 725 is designed so that a space is reserved for overlaying the Game Video 410. The Display Manager 450 scales and shifts a resulting Game Video 752 so that it is positioned above the reserved area on the Player Tracking Unit Video 725 in the shared display 750. In an alternative embodiment (not shown), an area of the screen layout on the game is reserved, and the Player Tracking Unit Video is overlaid on top of the game. This might be reserved for such information as player name, credits available, or other game or system information.

Referring now to FIG. 25C, a transparency scenario is depicted. In this embodiment, the Player Tracking Unit Video 720 is overlaid on top of a Game Video 411 in the shared display 750. The Game Video is able to be viewed through a resulting Player Tracking Unit Video 722 with a customizable level of transparency from 0% (Player Tracking Unit Video is completely opaque) to 100% (Player Tracking Unit Video is completely transparent). In another embodiment, it is advantageous and aesthetically pleasing to alter this level very quickly in a short period of time. When the level changes from 0 to 100 or alternatively from 100 down to 0, continuously or at certain values in the range, the resulting effect is for the Player Tracking Unit Video 722 to fade in or fade out over the Game Video 711.

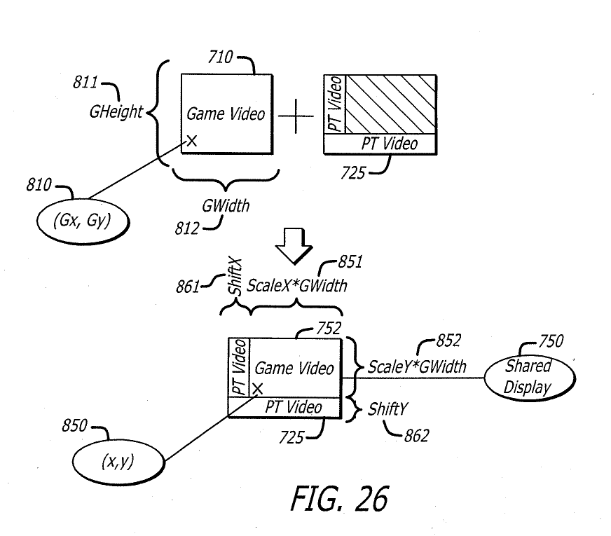

FIG. 26 shows the scaling performed on the Game Video to a desired size that conforms to the size and shape of the curved material 12. In this embodiment, the Game Video 710 is scaled and shifted and displayed Picture-in-Picture 752 on the shared display 750. The original Game Video height (“GHeight”) 811 and width (“GWidth”) 812 is scaled horizontally by a factor of ScaleX (0 to 100%) and vertically by ScaleY (0 to 100%). A resulting Game Video 752 has a width of ScaleX*GWidth 851 and a height of ScaleY*GHeight 852. The scaled Game Video 752 is shifted horizontally by ShiftX 861 and vertically by ShiftY 862, so that its lower left coordinate (0,0) on the original Game Video 710 is physically located at coordinate (ShiftX, ShiftY) on the shared display 750. Coordinate (Gx, Gy) 810 on the Game Video 710 would be translated to (x, y) 850 on the shared display 750 in such a way that:

x=ShiftX+(ScaleX*Gx)

y=ShiftY+(ScaleY*Gy)

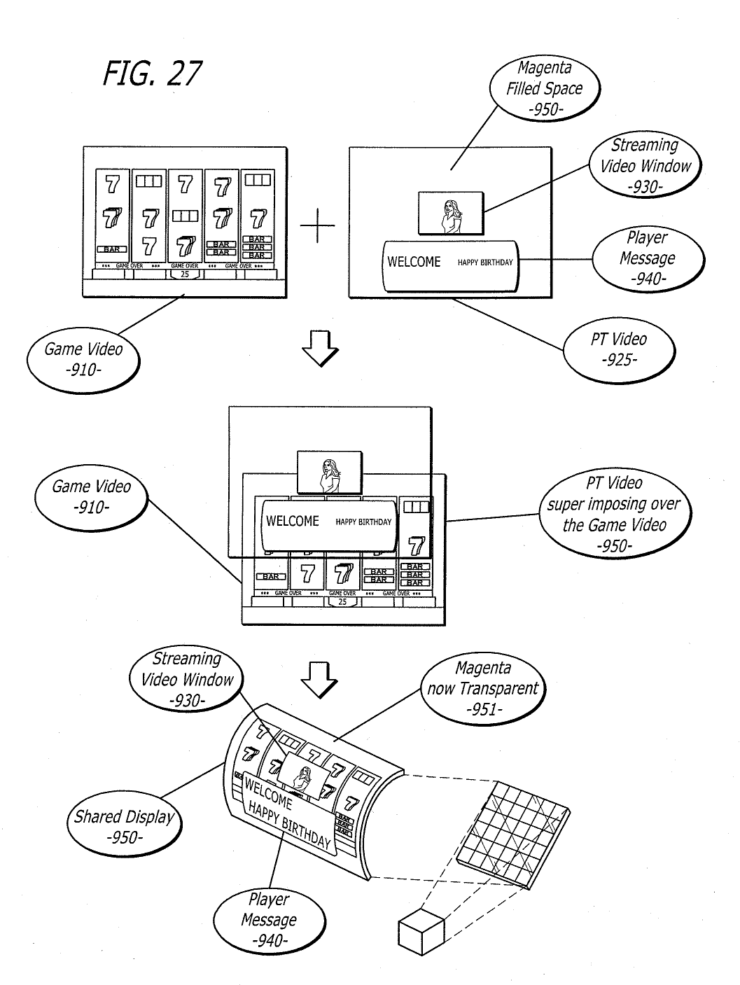

Still in another embodiment, one video input is superimposed over another, allowing part of a first video signal to be fully transparent, thus allowing the second video signal to be completely visible at those coordinates, while having other parts of the first video signal to completely obscure the second signals at other coordinates. FIG. 27 is a diagram demonstrating one embodiment where a system video signal is superimposed over the Master Game Controller signal. In a non-limiting example, a Game Video 910 shows a five-reel video slot game. In other non-limiting embodiments, the Game Video may be video from any electronic video game, such as video reel slot games, video poker, video blackjack, video roulette, video craps, video keno, and video and electronic bingo. One skilled in the arts will appreciate that the wagering game video source could include any existing or future wagering game, including a 3D video game, dexterity-based skill games, knowledge-based skill games, lottery terminals, and the like.

A Player Tracking Video 925 is shown as a single screen with three areas of interest. First, there is a streaming video window 930 presenting some video-on-demand. Second, there is a player message window 940 presenting a welcome message to a recognized player. In one embodiment, the player is recognized by inserting his loyalty or player's club card into a card reader on the gaming machine 400. The Player Tracking Unit 440 reads the identification number and requests the player name and other player information from the slot system or CMS. Once the information has been sent to the player device, it then displays one or more messages applicable to this player, including possibly target advertisement, personal, or other messages.

In another embodiment, the Player Tracking Unit may recognize the player through a biometric face or retinal camera. Still, in another embodiment, the Player Tracking Unit may recognize the player through finger print recognition technology by either having the player touch or swipe his finger across a reader, or by having the reader embedded in another peripheral, such as a button or touch screen. The third area of interest on the Player Tracking Unit Video 925 is the remaining unused screen area 950 that has been colored Magenta.

In other non-limiting embodiments, this color could be green, blue, or any other color that is guaranteed not to show up in the other used areas of the screen. The Display Manager 450 super imposes 949 the Player Tracking Unit Video 925 on top of the Game Video 910. The resulting Shared Display 950 shows the super-imposed image including the Streaming Video Window 930, the Player Message Window 940 unchanged, and now the remaining screen which is now transparent 951, although it is Magenta on the original video signal.

In still another non-limiting embodiment, the opaque areas of the super imposed images 930 and 940 may apply a customizable level of transparency from 0% (completely opaque) to 100% (completely transparent). In another embodiment, it is advantageous and aesthetically pleasing to alter this level very quickly in a short period of time. When the level changes from 0 to 100 or alternatively from 100 down to 0, continuously or at certain values in the range, the resulting effect is for the super-imposed image 925 to fade in or fade out over the background image 910.

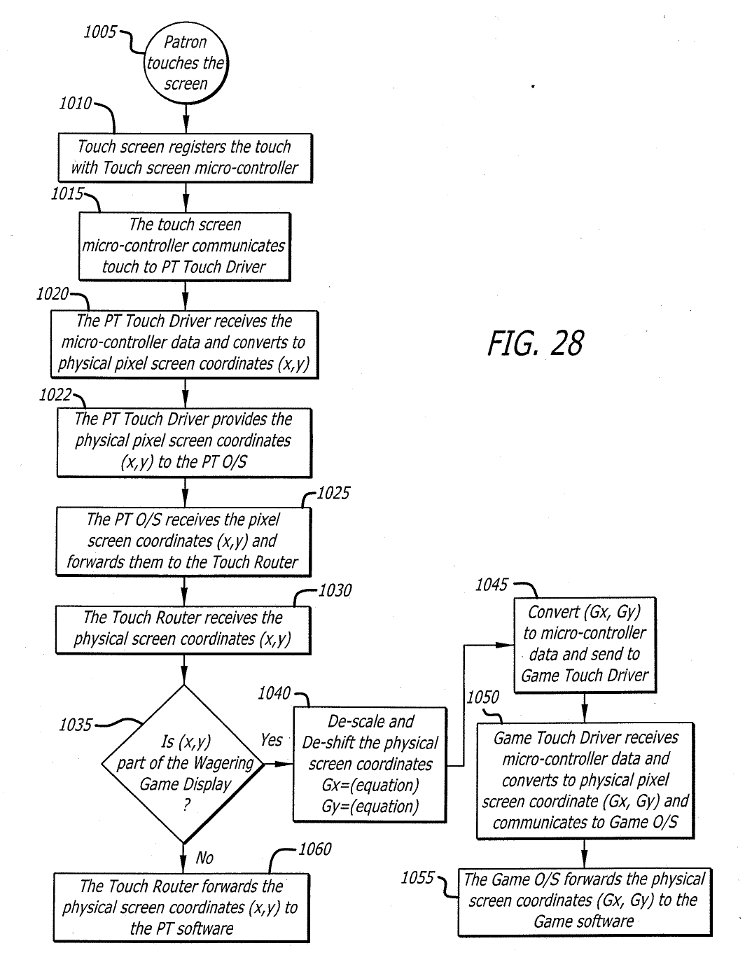

Turning to FIG. 28, a flowchart is shown charting the touch screen signal from a player's touch to the final software endpoint receiving the relative pixel screen coordinate. In use, the player touches the screen 1005 which is registered with the touch screen micro-controller 1010. The micro-controller communicates the touch signal to the Player Tracking touch driver 1015, which interprets the micro-controller protocol to calculate the physical pixel coordinates (x,y) of the touch 1020. The Player Tracking Unit touch driver provides these coordinates to the Player Tracking Unit OS 1022 such as Windows.

Other non-limiting embodiments associated operating systems are Linux, OSX, QNX, MS-DOS. The Player Tracking Unit 440 O/S receives the physical screen coordinates of the touch (x,y) and forwards them to the Touch Router 1025. The Touch Router receives the coordinates (x,y) 1030 and makes a determination 1035 if the coordinates refer to a location currently displaying video from a video source other than the Player Tracking Unit 440, e.g., a Wagering Game executing on a Master Gaming Controller 410. If the source is from an application running on the Player Tracking Unit 440, the Touch Router forwards the physical screen coordinates (x,y) to the Player Tracking Unit software 1060. However, if the touch corresponds to a video signal from the Master Gaming Controller 410, the Touch Router calculates the coordinates (Gx, Gy) from the perspective of the originating video source.

In one embodiment, the game screen coordinates are calculated 1040 from the scale factor (ScaleX, ScaleY) and shift values (ShiftX, ShiftY) employed to scale and shift the game video signal onto the shared display, as exemplified in FIG. 26. In this way the (Gx, Gy) coordinates would be calculated in such a way that:

$$Gx = \frac{( x - ShiftX )}{ScaleX}$$

$$Gy = \frac{( y - ShiftY )}{ScaleY}$$

The Touch Router converts the calculated coordinates (Gx, Gy) to a micro-controller protocol sent to the Game Touch Driver 1045. The Game Touch Driver receives the micro-controller data and converts to the physical screen coordinates (Gx, Gy) and communicates these coordinates to the Game O/S 1050. Then, the Game O/S forwards the coordinates to the Game Software 1055.

In another embodiment, the determination logic 1035 may be embedded in the Player Tracking Unit software managing the screen displayed in the Player Tracking Unit Video. The Player Tracking Unit software determines if the touch is on an active part of its display (e.g., a visible portion) or a non-active portion (e.g. a transparent portion or outside the range of an active display). If the touch is on an active portion, it handles the touch through its normal method. If the touch is on an inactive portion, it forwards the (x,y) coordinate to the de-scaling and de-shifting component which converts coordinates and forwards them to the appropriate device, e.g., the device providing the video source on which the player touched.

In still another embodiment, system-rendered content may be shown on a small iVIEW display (640×240) and a primary game display (main or secondary). A player may elect to have the data shown on one or both screens simultaneously. Triggering events may force the larger primary game screens to render the media to provide the best customer experience.

In some embodiments, the PIP windows may slide in or out of view when they are not needed. They may also fade in or out as needed as well. Monitored data from the game, Player Tracking Unit device or a server may trigger these windows (PIP) to appear/disappear based upon business rules or thresholds.

In some embodiments a player may reposition/resize any PIP window, and all of the other graphics will automatically or manually re-organize/rescale/resize. Player-preferred screen configurations may be saved for later use on this or another gaming machine at a later data. This configuration data is stored in a save state server and associated with a player identifier, a game identifier, and a cabinet/display identifier. A player is provided with a configuration screen to set the desired modes. Level of transparency for any and all windows is also configurable for a player and may be maintained in the save state server. A player may configure how they want to look at the game to build a fully customizable gaming experience.

There is a growing demand in the gaming environment for a video and touch screen switching hardware device, system, and/or method. An embodiment of such a device, system, and/or method mixes (e.g., switches, arbitrates, redistributes, routes, or the like) the VGA outputs from both the iVIEW (or other system gaming/Player Tracking Unit) and main game processor board to drive either or both the main game and secondary displays. Furthermore, the device would intelligently route touch screen events to either the game or iVIEW software components. The device would allow multiple windows driven by the base game and system components to simultaneously be shown on the same display(s). One embodiment of a video and touch screen switching device provides a migration strategy for current iVIEWs (or other system gaming/Player Tracking Unit) with some quick immediate modifications, and requires little or no work for gaming manufacturers to implement.

A preferred embodiment of a video and touch screen switching device maintains a wall of separation between the regulated gaming devices and their associated gaming equipment. The embodiment enables an operator to provide differentiated customer experiences on their games, and also consistent customer experience for their systems and every other part of their casino and brand. This embodiment enables the above-described, operator-desired functionality, meaning that differentiated experiences are pushed to each game manufacturer and exist on the gaming device, while consistent experiences may be implemented by a single vendor and exist on the associated equipment device, or possibly an adjunct gaming device accessory (depending on regulatory requirements). This embodiment addresses customer demands in a relatively quick manner, provides more satisfaction for the customer, and may be more palatable for other manufacturers.

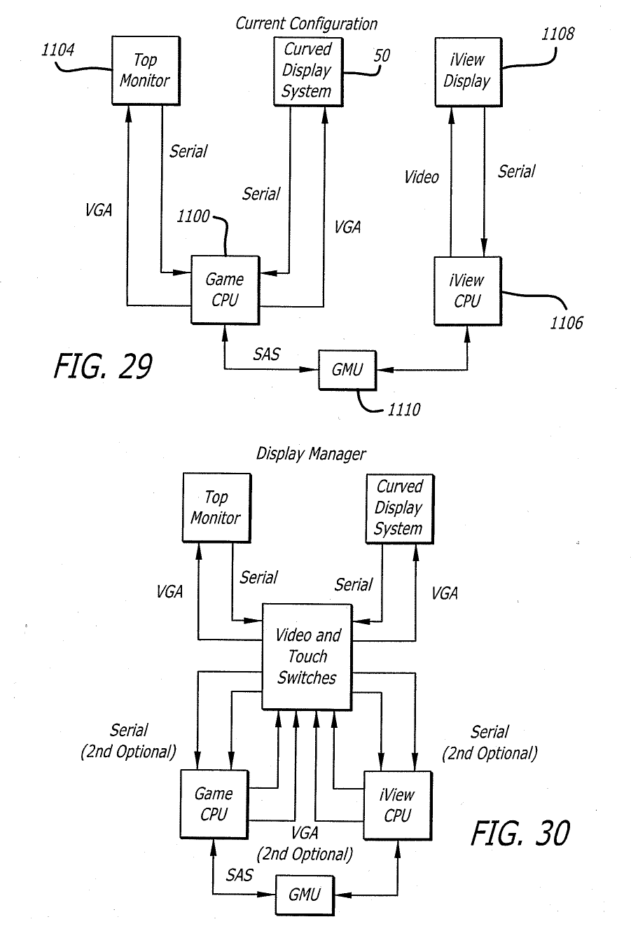

One embodiment of the Display Manager (see FIG. 29) generally includes the game CPU (or Master Gaming Controller 1100) connected to the curved display system 50 and/or top monitor 1104 using standard VGA connection. As shown in FIG. 29, the curved display system includes at least the DLP projector, curved material and touch screen system. A touch screen on either of these devices is connected to the Game CPU via a serial connection. The iVIEW processor 1106 is integrated with the small 640×240 iVIEW display 1108. The iVIEW has a serial touch screen. Both the Game CPU and iVIEW (or other system gaming/Player Tracking Unit) connect their audio into a separate switching device, allowing volume setting and balancing by a slot tech. A Game Monitoring Unit (“GMU”) 1110 is connected to the base game. It has also been contemplated that the top monitor in this embodiment could be replaced with another DLP display screen, and the DLP projector can be used to project an image on the top DLP display screen.

In one embodiment shown in FIG. 30, a Display Manager (i.e., Game/System Switcher) includes a video and touch screen switcher disposed between the touch screen displays of the top monitor and of the curved display system, and the Game CPU and iVIEW, allowing the Game CPU and iVIEW to effectively share the devices. These switchers may be either software or hardware. In one embodiment, a small hardware video switcher would be used along with implementing the touch switcher in software running on the iVIEW. In this embodiment, the Display Manager receives two VGA signals to be mixed and rendered, without copying and/or saving of the original signals (e.g., switched, arbitrated, redistributed, routed, or the like), and sends the signals to a first display system via a first VGA output signal.

In another embodiment (not shown), game display and any system information may be presented on the curved display using the processing power of the Game CPU. Both the system display and the game display are driven by software on the Game CPU with a single video source (Game CPU) and touch screen source (touch screen system associated with the curved display system). In this embodiment, the system software (and any associated equipment software) and the game software are isolated from one another, thereby allowing for individual approval of each software module. However, both the system software and game software run concurrently on the Game CPU. The Game CPU coordinates the use of the curved display system and the touch screen system.

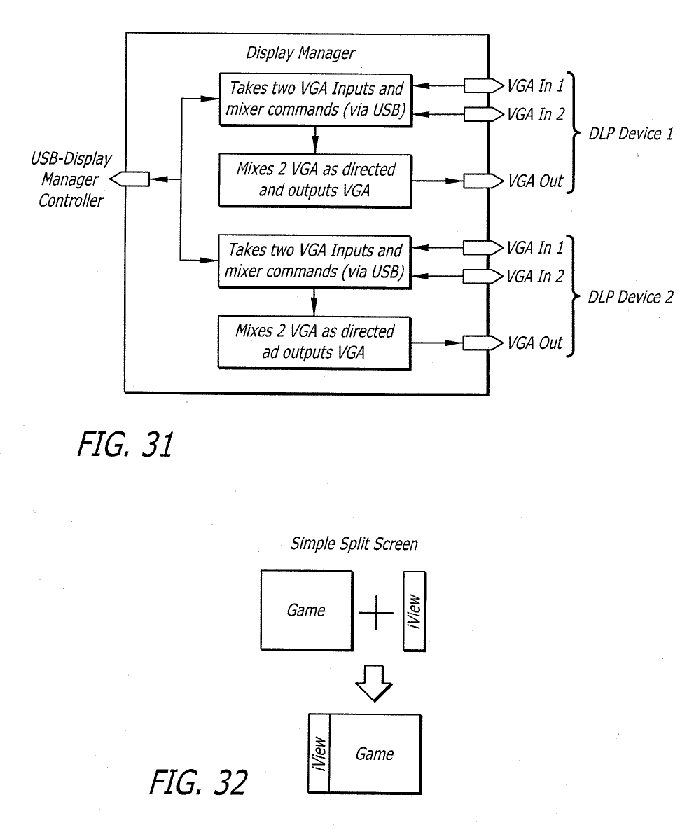

In another embodiment as shown in FIG. 31, an option is extended to two DLP devices. The Display Manager receives two additional VGA signals to be mixed and rendered, without copying and/or saving of the original signals (e.g., switched, arbitrated, redistributed, routed, or the like), and sends the signals to a first DLP device via a first VGA output signal and to a second DLP device via a second VGA output signal. Mixing commands may be received from the iVIEW via a USB connection. In yet another embodiment, an option can be extended to one DLP device and one monitor.

In its most simple implementation, the game content may be scaled, and iVIEW content may be placed beside it in a split screen configuration, as shown in FIG. 32. In this embodiment, the iVIEW (or other system gaming/Player Tracking Unit) instructs the Display Manager to scale the game VGA signal to allow enough room for the iVIEW content by supplying the overall coordinates (top, left, height, and width). The iVIEW then instructs the Display Manager to display the iVIEW VGA signal in the upper left corner, again by supplying the appropriate coordinates. The iVIEW has the intelligence to know the existing game state and player tracking state and may re-size, scale, or position windows based upon business rules.

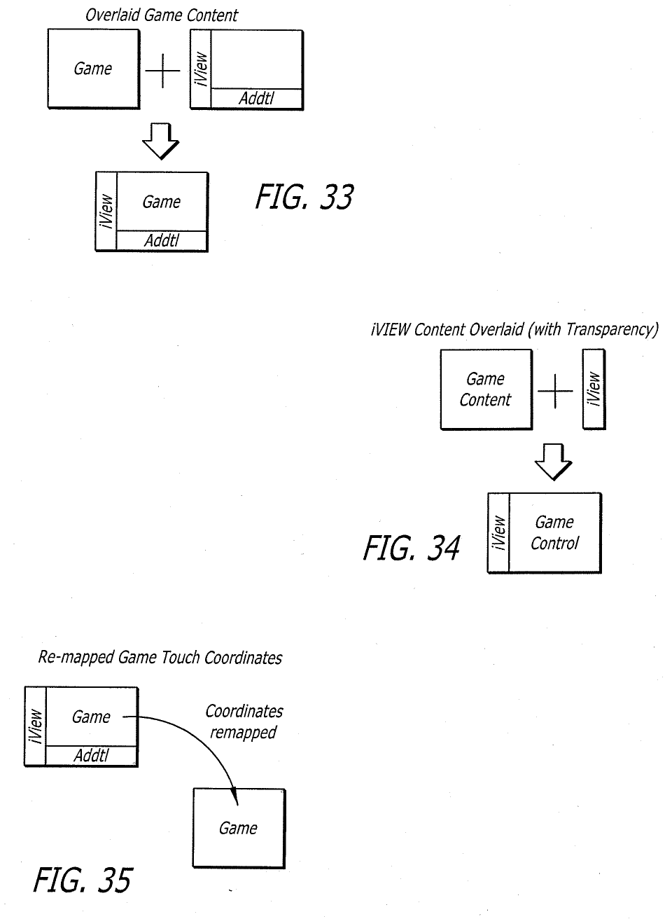

In order to preserve the aspect ratio of the game and minimize distortion, the iVIEW may accommodate a full-size screen display, leaving a space for the game content of appropriate proportions as shown in FIG. 33. This technique opens up real estate on top and bottom of the game window. The iVIEW (or other system gaming/Player Tracking Unit) then instructs the Display Manager to display the iVIEW content full screen and to overlay the scaled game window in the appropriate location.

Alternatively, in another embodiment, the iVIEW (or other system gaming/Player Tracking Unit) may instruct the Display Manager to display the game content full screen and overlay the iVIEW content (e.g., System Window) on top of the game content as depicted in FIG. 34. Additionally, the Display Manager supports transparency, allowing the game content to be visible through the iVIEW content.

The iVIEW receives physical screen coordinates via the standard touch screen. Using its knowledge of how the game content is positioned (since it instructed the Display Manager where to place the game content), the iVIEW may determine if the user touched the game content on the screen. Referring to FIG. 35, if the game content was touched, iVIEW passes the relative coordinates to the Display Manager, which calculates what the physical coordinates would have been if the game content had not been scaled. The Display Manager then passes these re-mapped coordinates by emulating the micro-controller of the touch screen. The touch controller is able to emulate the standard touch controllers on the floor.

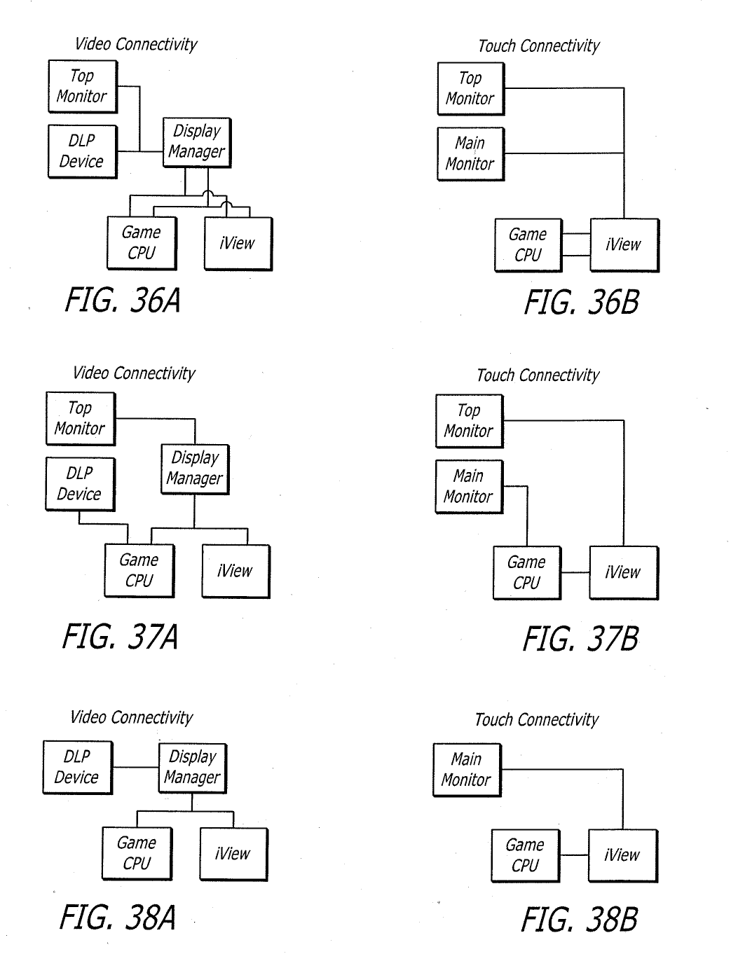

The Display Manager device, system, and method disclosed herein is adaptable to the various cabinet styles on the slot floor. In the case of a video cabinet sporting a top monitor, this Display Manager may drive the DLP device 18 of the curved display system and the top monitor simultaneously, depending on the processing power and VGA connections of the iVIEW (or other system gaming/Player Tracking Unit). Referring to FIG. 36A, the Display Manager (i.e., video switcher) receives two VGA inputs from the Game CPU and two from the iVIEW and plugs into the VGA ports of the DLP device and the top monitor. The Display Manager receives commands from iVIEW on how to re-render (e.g., switch, arbitrate, redistribute, route, or the like) game content or iVIEW content or a combination of both on one or both screens, possibly simultaneously. Likewise, as shown in FIG. 36B, upper and lower touch screens plug directly into COM ports on the iVIEW. The Game CPU plugs both of its serial connections into the iVIEW board. The software touch switcher on the iVIEW receives inputs from the two touch screens and sends the re-mapped coordinates to the Game CPU on the appropriate serial connection.

Driving the DLP device and the top monitor simultaneously enables persistent secondary content to display on the top monitor (e.g. advertising, secondary games) where it is easily viewed by both the player and others that might be in the surrounding area while placing short-lived, customer interactive content (e.g., Service window menus, and the like) on the main game monitor, which is better positioned ergonomically for customers' interaction.

In one non-limiting embodiment in which the iVIEW lacks the processing power or necessary ports to drive both the DLP device and the top monitor and of a dual display cabinet, the Display Manager (i.e., game/system switcher) may be configured to drive only one of the DLP device or the top monitor. In this embodiment, the Display Manager as shown in FIG. 37A only receives the VGA input from the shared monitor and the iVIEW. The software touch switcher as shown in FIG. 37B on the iVIEW has a COM connection to the shared touch screen and a single COM connection to the Game CPU. The main monitor (including the curved display system 50 and touch screen system 54) is still dedicated to the game by maintaining its direct VGA and COM connection to the Game CPU.

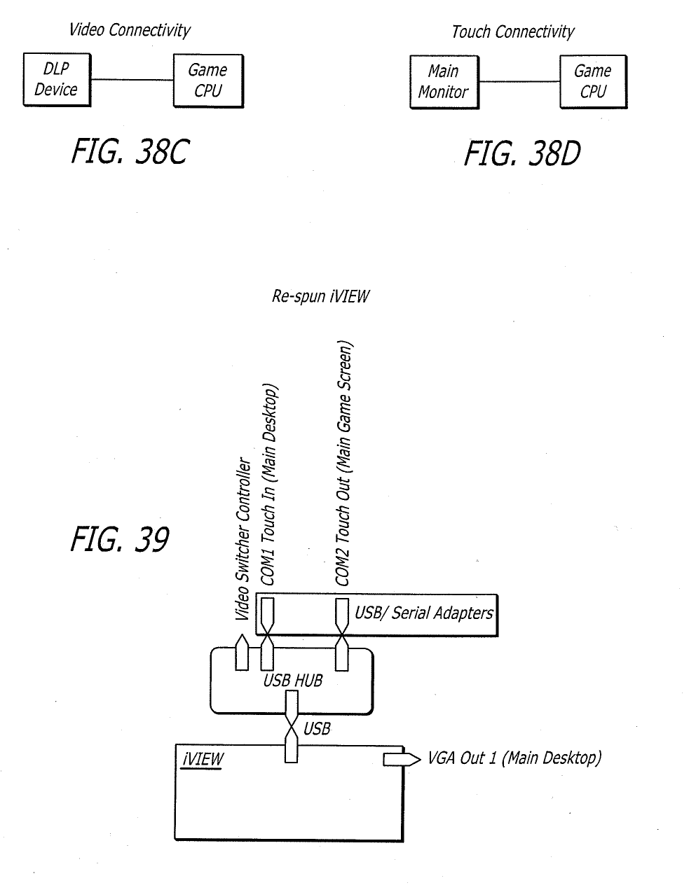

In FIGS. 38A and 38B, the case of a video cabinet with no top monitor is shown and is similar to the previous embodiment. The Display Manager is configurable to support different resolutions and aspect ratios (e.g., widescreen displays and curved displays).

In another embodiment, shown in FIGS. 38C and 38D, the Game CPU controls the display of system information and game information without the Display Manager or iVIEW. Additionally, the touch screen source (touch screen system associated with the curved display system or main monitor) is connected directly to the Game CPU. In this embodiment, the system display (and associated equipment software) and the game software are isolated from one another, thereby allowing for individual approval of each software. Both the system software and game software run concurrently on the Game CPU. The Game CPU coordinates the display of the system and game information on the curved display and the use of the touch screen system associated with the curved display system.

In a preferred embodiment of the Display Manager device, system, and/or method, the game manufacturer does not have to take any additional actions to utilize the functionality of the device, system, and/or method. In some embodiments, a few event exception codes may be incorporated to G2S (Game to System) and/or SAS (Slot Accounting System), but an immediate benefits to manufacturers is the minimization of any costly development, QA, and/or manufacturer submissions.

In one embodiment, system-related features remain with system providers, and system-only peripherals remain independent of the base Game OS. As a result, operators may continue to enjoy rapid development and deployment of system features across the floor. A single implementation of new system features continues to ensure that customer experiences are consistent, independent of various implementations and capability differences across the various devices. Remote host providers may work with a single vendor to develop and support any third-party system capabilities. A single implementation provides consistency in the capabilities in the run-time environments on the floor. A single system manufacturer may easily and more quickly define system parameters and establish agreements for ensuring content runtime environments, thereby reducing the number of variations the content developers need to develop and support.

Similarly, a single system manufacturer may control the prioritization algorithms for displaying content across the floor. Operators may work with a single vendor to ensure that high priority content is displayed appropriately, e.g., simultaneously, in a timely manner. Keeping common software infrastructure components (e.g. Flash player), potentially used by third parties, are more likely to remain up-to-date since updating them is dependent only on a single manufacturer and platform. Systems functionality remains on associated equipment reducing the risk increased regulatory overhead. Additionally, new cabinets are not required for customers to benefit from this technology.

The Display Manager offers benefits to the operators and industry. Depending on desired capabilities, this embodiment provides the operator with a migration strategy and the opportunity to preserve a portion of their investment in iVIEWs (or other system gaming/Player Tracking Unit) that they currently own. The existing board supports basic single-display mixing (e.g., switching, arbitrating, redistributing, routing, or the like).

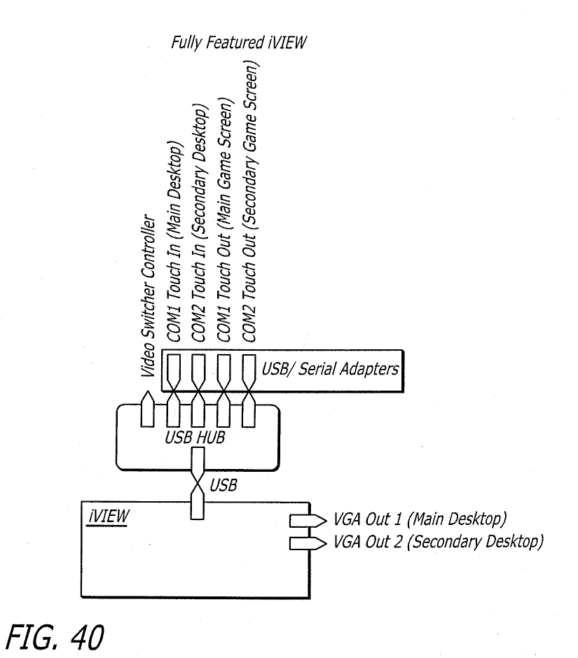

An operator may upgrade any currently owned iVIEW (See FIG. 39) to provide a game monitor system window, a top monitor display, or both. As a result, the operators do not need to decide whether to purchase iVIEWs (or other system gaming/Player Tracking Unit) today or wait for a shared display solution. When the shared display solution is available, or otherwise timely to acquire, they may upgrade their machines, not only avoiding the full cost of the new capability, but also possibly extending the life of their exiting iVIEWs' processor. Once enhanced system gaming/Player Tracking Units are available (See FIG. 40), operators may purchase those on new machines moving forward.

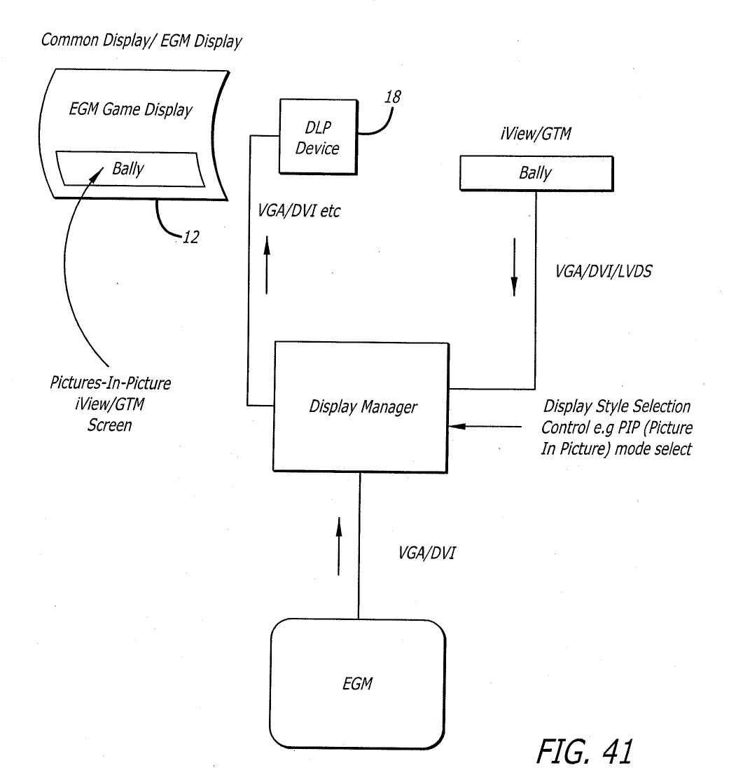

Referring now to FIG. 41, in another embodiment, the Display Manager combines the screen content from two or more sources without affecting the physical construction of the devices connected to it. The mixing mode of the input screens depends on an external input using a USB or serial interface. Preferably, a Display Manager is an image processing unit that has two or more VGA/DVI (and possibly LVDS) inputs and a VGA/DVI output. Additionally, the mode select is another control input to the Display Manager that also acts as an input for dynamic size change commands. The Display Manager may utilize USB, RS-232, or another suitable protocol. The above-described input path may also be utilized for the upgrading of the Display Manager. In another embodiment, a coaxial input may be used to feed a Television/Tivo/DVR (digital video recorder) signal directly into the Display Manager.

In one such embodiment, the basic construction of the Display Manager is shown in FIG. 41. Specifically, the Display Manager may be used to generate a Picture-In-Picture mode. The common display is currently showing the gaming machine screen. The iView/GTM (Game Terminal Manager) has an important message that needs to be displayed on the main screen. A screen display mixing style PIP (Picture-In-Picture) is selected using the USB/Serial interface. The Display Manager combines the signal, performs the required image processing, and then provides the input to a DLP device (or a common display) to project a combined image onto a screen (including a curved material 12). The common display shows the main game with a PIP of the iView/GTM message screen. The size of the PIP screen may also be dynamically changed using the selection input.

In such an embodiment, the control input may be used for screen mixing selection or for the size of the effects. For example, the screen mixing selection may be used with any of the following styles: PIP, POP (Picture-on-Picture), dissolver, fader, and vertical/horizontal/multimode screen splitter. Additionally, the size of the effects may be varied (e.g., the split screen or the PIP image size and position may be dynamically changed using the control input). Moreover, the Display Manager may be extended to more than two inputs so that a third input from a standard TV/Tivo/DVR may be connected to use any of the mixing styles for display on the main screen.

In a preferred embodiment of the Display Manager, display mixing effects may be implemented without any modifications to the current gaming machine or GTM hardware. Both the GTM and the gaming machine do not require any additional software changes other than the mode control. Even this change may be eliminated if the mode is a fixing mode (e.g., only PIP). Additionally, the Display Manager simplifies the implementation of the display mixing in all currently-existing filed hardware, because only a simple VGA cable has to be connected to the Display Manager instead of the gaming machine.

Referring now to the Display Manager software and configuration, the Display Manager operating system and content include left, right and bottom display panels. The operator has the option to select a panel that best suits the base gaming machine. The operator changes the screen configuration by entering the employee page and selecting the “Change DM Config” button.

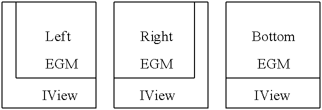

In one embodiment, an iVIEW controls the touch screen remapping of the gaming machine and iVIEW, as well as controlling the Display Manager. The Display Manager mixes the video outputs from the iVIEW and the main gaming controller, and displays the combined image on the game screen. The iVIEW OS controls the screen layouts via serial link to the Display Manager board.

Preferably, the iVIEW board performs touch screen remapping of the gaming machine and iVIEW screen. Touch screen inputs from the video area corresponding to the main game are routed to the game and inputs from the iVIEW area are routed to the iVIEW application. The touch screen management is performed by the iVIEW using a USB to Serial Port Converter. This system is compatible with the existing SDS (Slot Data System) environment and does not require modification to the main game OS.

In one embodiment, the iVIEW operating system in the SD card is Microsoft Windows CE. The SD card also holds the iVIEW content, which may be customized for advertising, messages to the player or other casino-designed promotional messages. The minimum recommended compact flash size is 256 MB. The content or Operating System (OS) can be updated by replacing the GTM SD card.

Both the operating system and content are signed and authenticated. The iVIEW hardware verifies the signatures of the OS and content. Additionally, the iVIEW launches the operating system and application after the files are verified. If any of the files on the SD card are modified, the iVIEW displays an error screen upon boot up. The casino may modify the content file (manufacturer folder in the SD card) but the new content must be resigned using the manufacturer DSA file signer (Level III signing). The operating system files may not be modified by the casino.

In one embodiment, the SD card content enables players to insert their cards to activate a standard player screen and request services, assistance, or other information with unavailable/non-supported items being “grayed out.” The employee card activates a standard interface screen with associated operator, regulator, and diagnostic/installation functions.

In one non-limiting example, the interface with the Gaming Monitoring Unit (GMU) software is consistent using previously used interfaces. The iVIEW uses a standard EPI port to connect to the GMU. Neither the iVIEW Operating System, Application, nor Content modify the meters or the accounting information stored and processed by the GMU.

This embodiment is compatible with (1) Capstone Display Manager Board with OS version fli8548_RD4_board_extv7.hex; (2) SDS 8.2.X or higher; (3) MC300 Game Monitoring Unit with ECO 2103 or higher; (4) iVIEW Sound Mixer (GLI file number SY-22-SDS-06-14); and (5) iVIEW touch screen display. Additionally, this embodiment introduces various enhancements and features, including (1) left, right and bottom Display Manager display screens; (2) new employee functions to select the left, right, or bottom Display Manager display screens; and (3) support for additional video resolutions (VESA-compliant; 640×480 to 1280×1024), video refresh rates (50 hz to 85 hz), video output (VGA and DVI), and touch screen serial interfaces (3M EX-II).

The Display Manager is a hardware component that mixes the iVIEW content and the game content and then displays the mixed content on the gaming machine's curved display system including touch screen system. Mixing the content for both the game and the iVIEW onto one screen provides players easier access for downloading credits from their accounts without interruption of game play or access to other player functions. The hardware component is installed between the iVIEW display and the gaming machine's monitor-touch screen.

In one embodiment, the following hardware and software are installed to connect and run the Display Manager feature: (1) iVIEW GTM (206978) with video pigtail (206970-00-0) and (2) DM operating system (OS). Additionally, in one embodiment, installation of the Display Manager uses the following components: (1) three USB Cables; (2) two USB to Serial Connectors; (3) USB Hub; (4) one Display Manager with VGA to DVI Converter, including a DVI cable; (5) one RS232 Serial Cable, Molex 8-pin from iVIEW J2 to 9-pin serial on the Display Manager; (6) one RS232 Cable USB Hub to monitor touch screen; (7) three VGA Cables (iVIEW VGA OUT to DM VGA to DVI converter IN, gaming machine Processor Board VGA OUT to DM VGA IN, and DM VGA OUT to gaming machine Monitor or DLP device VGA IN); (8) one RS232 Null Modem Cable (USB Hub to gaming machine processor board touch screen 9-pin serial connector).

In another aspect of one embodiment, the Display Manager operating system (OS) and content held on the iVIEW SD card are upgraded when installing the Display Manager software. Typically, this is performed by inserting the SD (Secure Digital) card into the SD socket on the iVIEW.

Further, in one non-limiting embodiment, the Display Manager hardware is installed by plugging each cable into the appropriate connector on each piece of hardware as follows: (1) USB cable from iVIEW USB Host to USB Hub; (2) USB cable/serial to USB converter connector from USB Hub to RS232 cable to curved display system and touch screen system; (3) USB cable/serial to USB converter connector from USB Hub to RS232 Null Modem cable to game machine processor board DB9 touch screen connector; (4) iView VGA OUT to Display Manager DVI converter box VGA IN port; (5) iVIEW RS232 to Display Manager serial 9-pin; (6) gaming machine VGA OUT to Display Manager VGA IN; (7) Display Manager VGA OUT to DLP device or monitor VGA IN; (8) DVI cable from Converter OUT to Display Manager Converter IN (Converter dipswitches 1, 5, and 10 should be in the ON position).

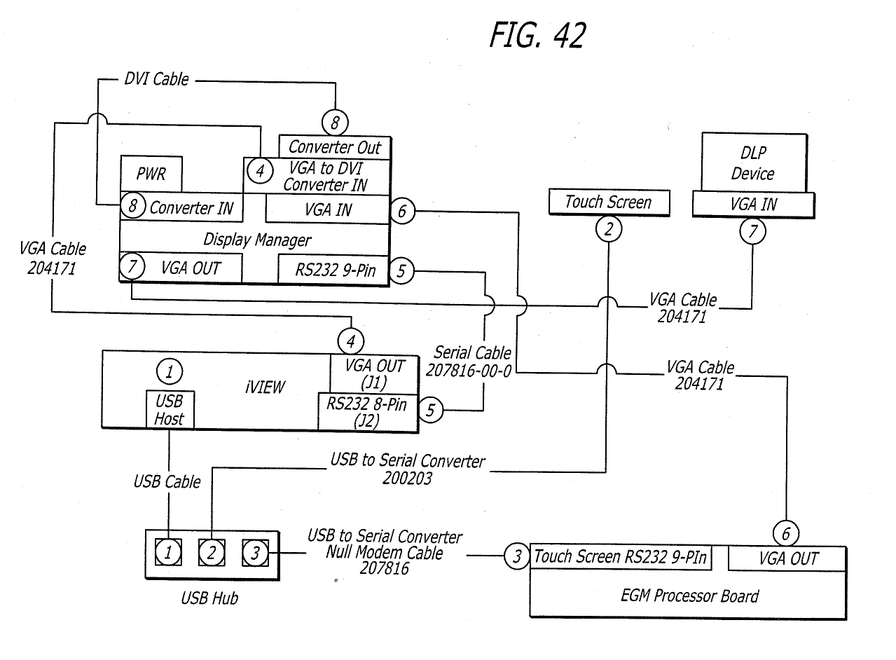

Referring now to FIG. 42, after the Display Manager software and hardware have been installed, the gaming screen (curved display system and touch screen system) is then configured. In one embodiment, the configuration is performed by accessing the employee mode to calibrate the touch screen system. Specifically, the touch screen is calibrated by accessing the employee mode, selecting touch screen calibration, and following the instruction prompts on the monitor for calibration.

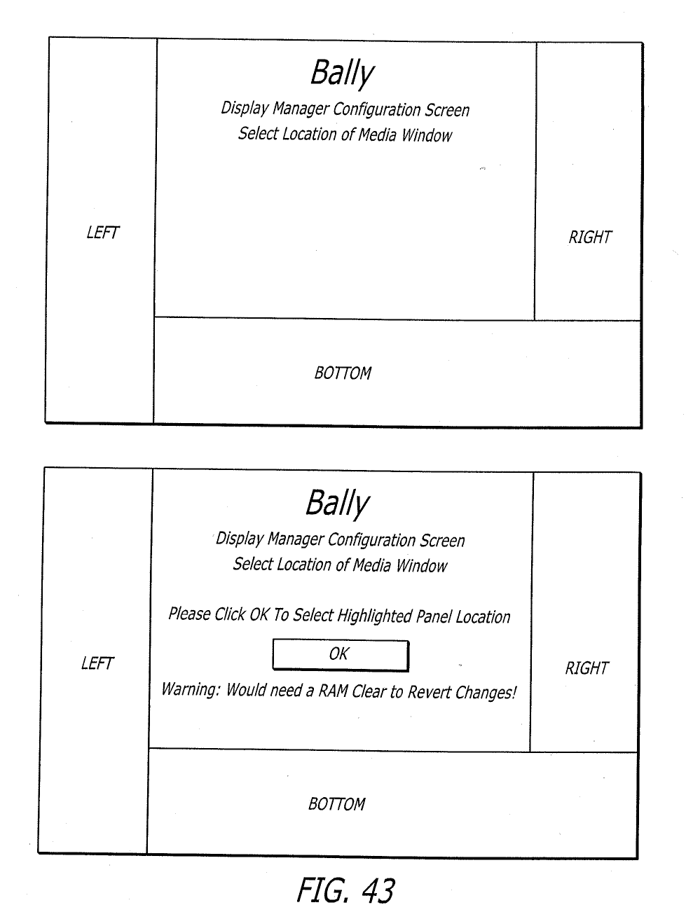

As shown in FIG. 43, a user (1) accesses the employee mode, (2) selects the Display Manager Configuration Screen, and (3) touches the area of the screen where the menu is to display. The typical configuration for video gaming machines is as follows:—For the Left: Bottom bar is always on. The Menu displays on the left side. The game shrinks to fit the upper-right. For the Right: The bottom bar is always on. The Menu displays on the right side. The game shrinks to fit the upper-left. For Spinning-Reel machines, select Bottom. After the settings have been selected, touch OK to save the settings.

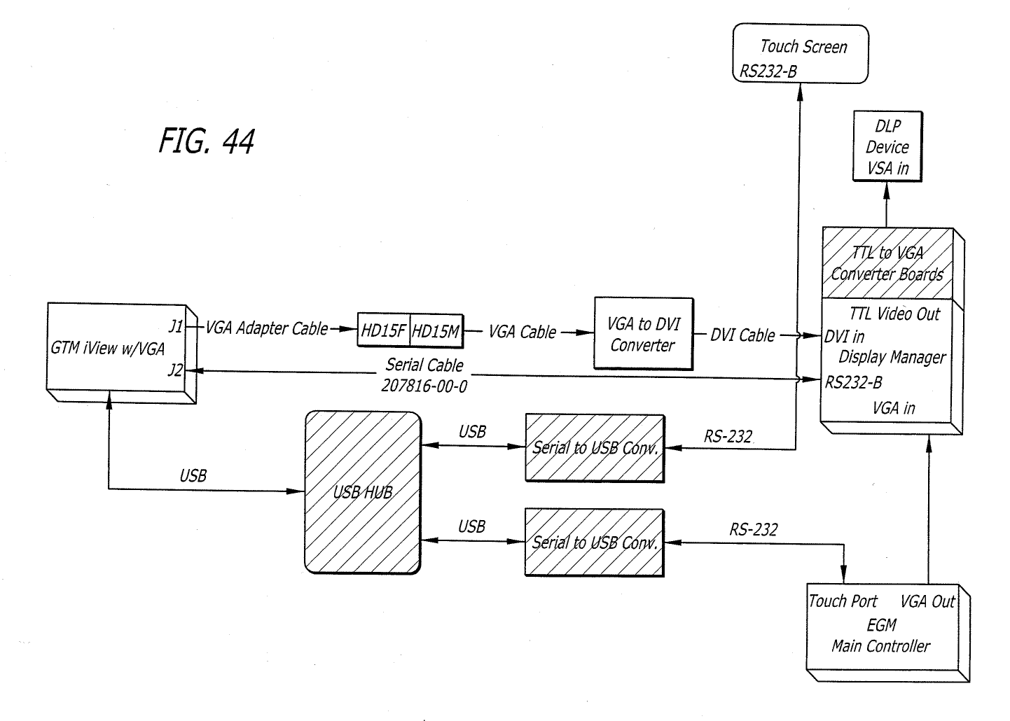

Referring now to FIG. 44, a component diagram of the Display Manager is shown in connection the EGM main controller (Master Gaming Controller), the iView, and the gaming machine's display screen (EGM display). Additionally, at least one possible non-limiting embodiment of the wiring of these components is shown. In another embodiment, the Display Manager is configured to support DVI & VGA on both inputs and output, eliminating the external TTL & DVI converters. In still another embodiment, touch scaling is incorporated into the Display Manager board, thereby eliminating the USB hub and serial-USB converters.

In yet another embodiment, Genesis FLI8668 scaler chip is used instead of the FLI8548 scaler chip. The Genesis FLI8668 scaler chip is more powerful and can support higher resolutions and more flexible PIP options. The FLI8668 scaler chip provides high integration for advanced, dual-channel applications of Picture-in-Picture (PIP) and Picture-by-Picture (PBP). Specifically, two videos decode with 3D comb filters and two channels of DCDi (Directional Correlation Deinterlacing) processing, and true 10-bit performance provides an extreme high-quality picture for a two-channel application.

Additionally, the FLI8668 scaler chip provides special performance features such as the Faroudja DCDi Cinema video format converter, blue stretch, DDR memory with a read-write of 10 bits per pixel, and flexible sharpening algorithms providing unparalleled performance. The FLI8668 scaler chip also includes an integrated Analog Front-End (AFE) that includes two triple ADCs, a cross-point switch, and two Faroudja Intellicomb™ 3D comb filters. The flexible AFE ensures simple PCB design with direct connections to TV tuners and input video connectors.

Genesis Microchip Inc., the maker of the Genesis scaler chip has been acquired by STMicroelectronics (NYSE: STM). Worldwide Headquarters located at STMicroelectronics, 39, Chemin du Champ des Filles, C. P. 21, CH 1228 Plan-Les-Ouates, GENEVA, Switzerland. One of ordinary skill in the art will appreciate that other equivalent (or better) scaler chips may also utilized without departing from the scope of the invention.

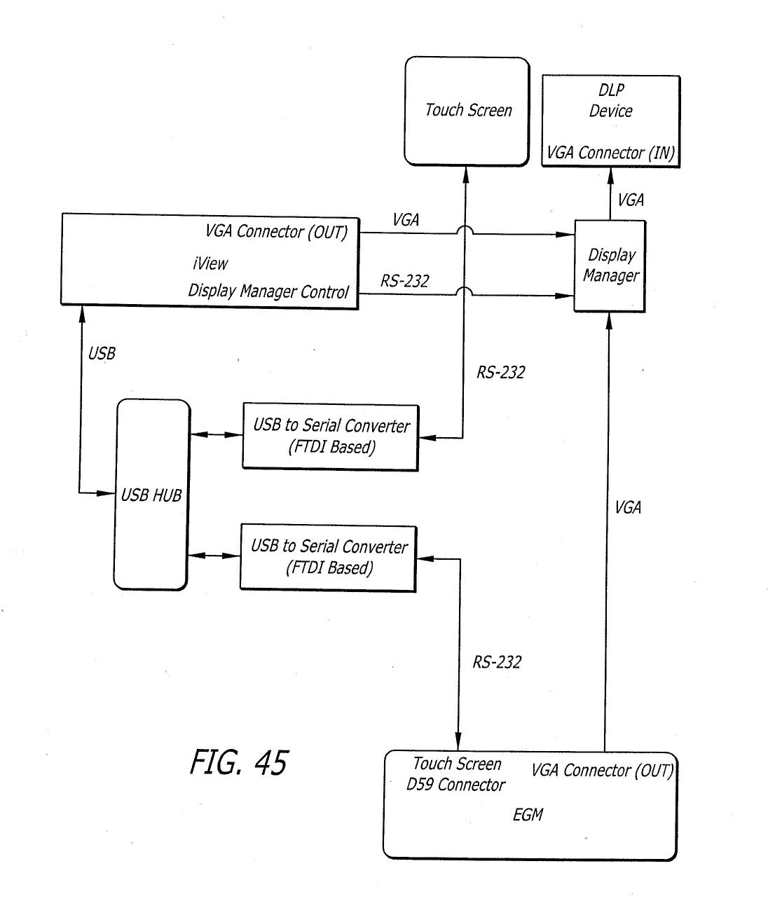

Referring now to FIG. 45, a simplified component diagram of the Display Manager is shown in connection the EGM main controller (Master Gaming Controller), the iView, and the Game Display. The component diagram shows both the video connections and the touch screen control.

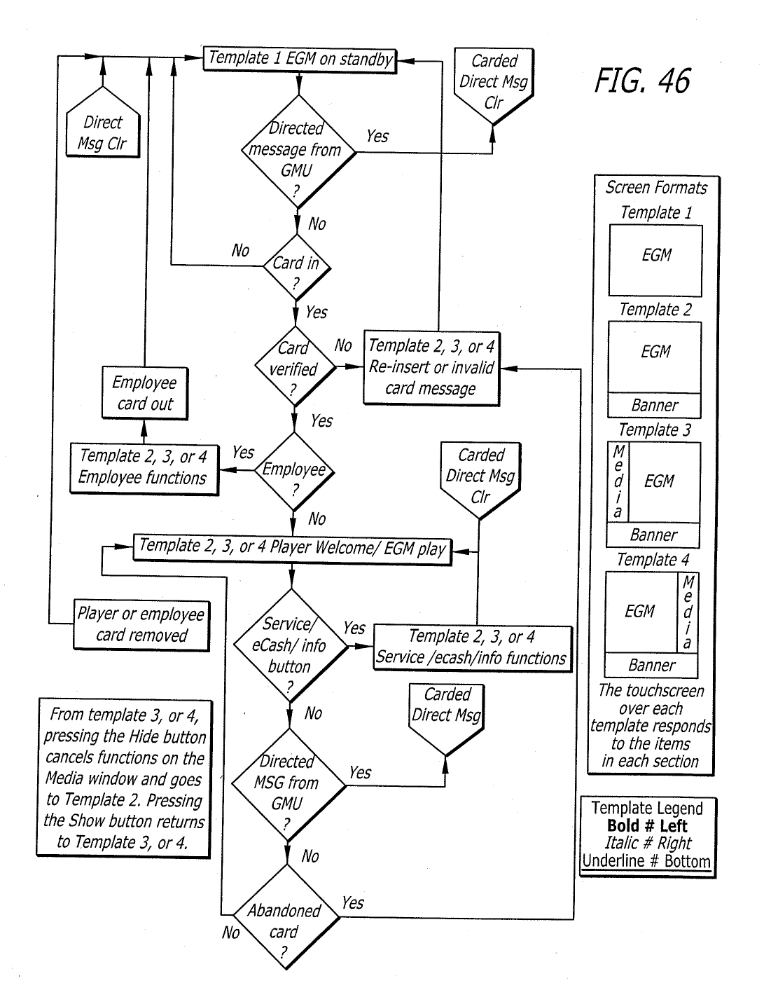

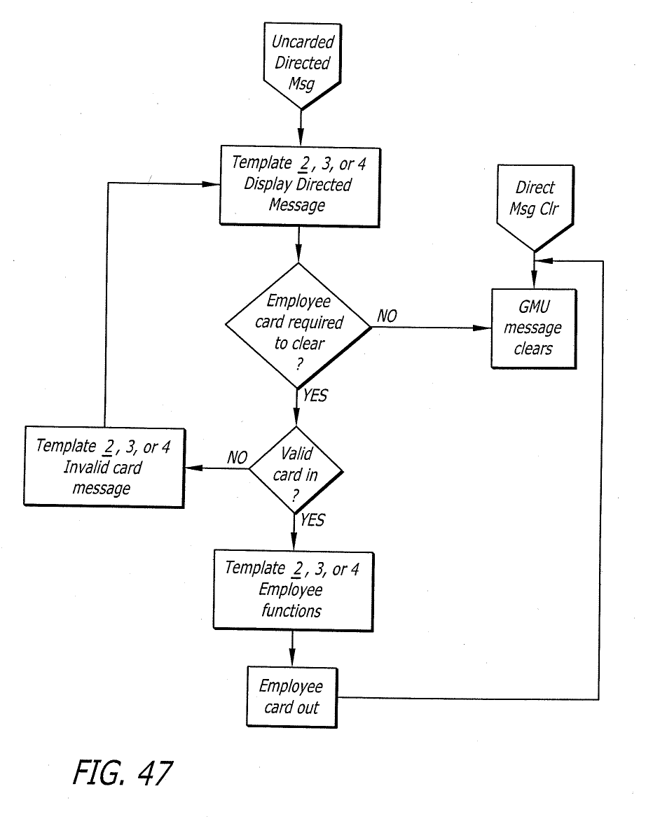

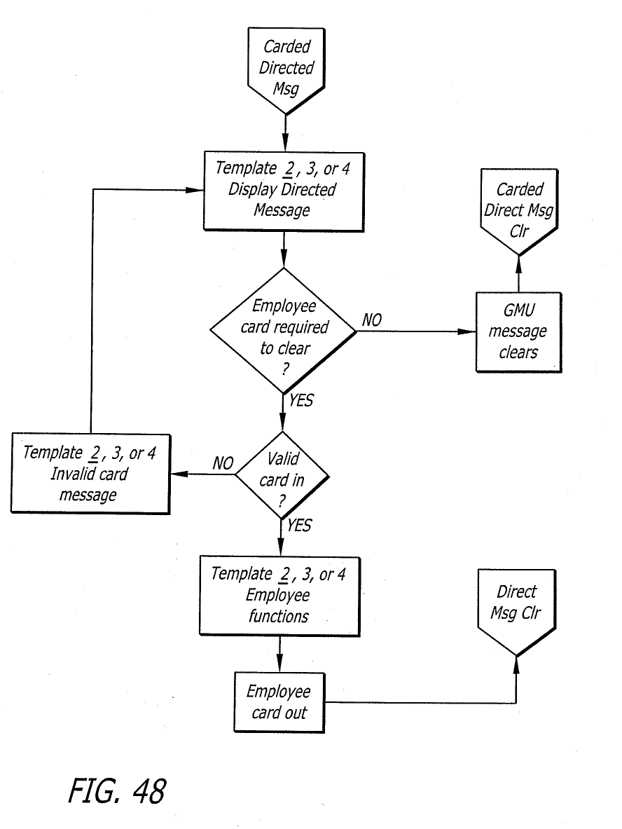

Referring now to FIG. 46, a logic flow diagram is shown of the Display Manager's basic functions. As shown in FIGS. 47 and 48, a logic flow diagram of uncarded direct messages using the Display Manager system is disclosed (FIG. 47) and a logic flow diagram of carded direct messages using the Display Manager system is disclosed (FIG. 48).

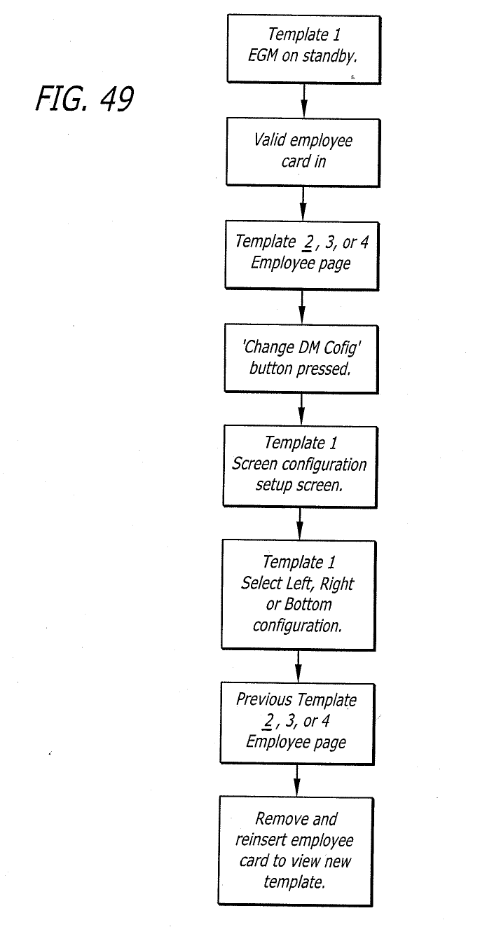

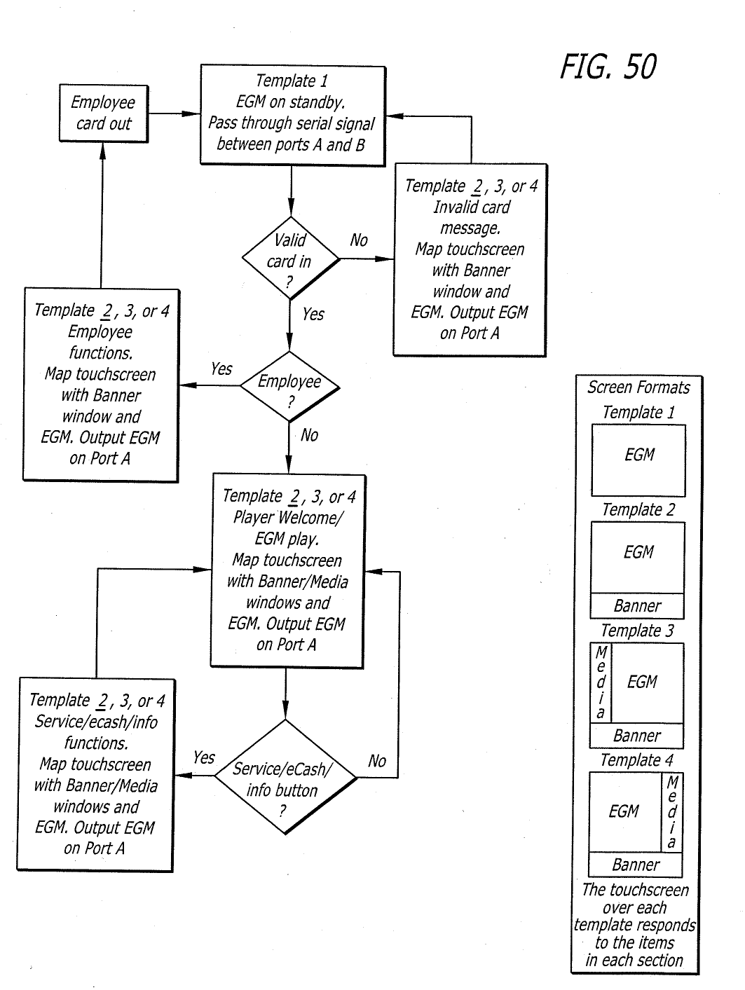

Referring now to FIG. 49, a logic flow diagram is shown of the additional Display Manager functions. Additionally, with reference to FIG. 50, a logic flow diagram of the additional serial touch screen functions is disclosed.

One of ordinary skill in the art will appreciate that not all gaming systems and methods will have all these components and may have other components in addition to, or in lieu of, those components mentioned here. Furthermore, while these components are viewed and described separately, various components may be integrated into a single unit in some embodiments.

The various embodiments described above are provided by way of illustration only and should not be construed to limit the claimed invention. Those skilled in the art will readily recognize various modifications and changes that may be made to the claimed invention without following the example embodiments and applications illustrated and described herein, and without departing from the true spirit and scope of the claimed invention, which is set forth in the following claims.

What is claimed:

1. A gaming system for presenting both game content-based video signals and secondary video signals in a single presentation, the gaming system comprising:
a touch screen display that displays video signals;
a curved display system including a curved transparent material and a projector for projecting video images onto the curved transparent material;
a gaming controller generating a first video signal including game content to be viewed on the curved display system;
a secondary video source generating a second video signal including secondary content to be viewed on the curved display system;
a touch router device in communication with the touch screen display; and
a display manager configured to scale at least one of the first video signal or the second video signal to a reduced size and renders the first video signal from the gaming controller with the second video signal from the secondary video source;
wherein the touch screen display receives an input that corresponds to coordinates and calculates a coordinate transformation on the coordinates that correspond to a determined source to accommodate any scaling performed on at least one of the first video signal or the second video signal, resulting in transformed coordinates.

2. The system of claim 1, wherein the curved transparent material of the curved display system having an outer surface, an inner surface, and a radius of curvature similar to a mechanical reel, the curved transparent material further having a glossy finish on the outer surface of the curved transparent material to provide a reflective surface.

3. The system of claim 1, wherein the secondary video source is a player tracking device.

4. The system of claim 1, wherein the display manager simultaneously displays the first video signal from the master gaming controller and the second video signal from the secondary video source on the curved transparent material using the projector.

5. The system of claim 4, wherein the display manager scales the first and second video signals to a desired size that conforms to the size and shape of the curved transparent material and renders the first video signal from the master gaming controller adjacent to the second video signal from the secondary video source in a split screen format.

6. The system of claim 4, wherein the display manager overlays the second video signal from the secondary video source on the first video signal from the master gaming controller on the curved display system.

7. The system of claim 6, wherein the overlaid second video signal from the secondary video source obscures at least a portion of the first video signal from the master gaming controller.

8. The system of claim 6, wherein the overlaid second video signal from the secondary video source includes a level of transparency enabling the first video signal from the master gaming controller to be at least partially visible through the second video signal.

9. The system of claim 8, wherein the display manager overlays the second video signal from the secondary video source on the first video signal from the master gaming controller with different levels of transparency in different areas of the curved display system.

10. The system of claim 1, wherein the display manager receives commands from at least one of the master gaming controller and the secondary video source directing the display manager to simultaneously display the first and second video signals from the gaming controller and the secondary video source.

11. The system of claim 1, further comprising a liquid crystal display having an opening, wherein the curved transparent material extends through the opening of the liquid crystal display.

12. The system of claim 1, further comprising a lens positioned in front of the projector, wherein the lens is a short-throw lens or an anamorphic lens.

13. The system of claim 1, wherein the projector projects video images of one or more reels onto the curved transparent material.

14. A gaming system for presenting primary video signals and secondary video signals in a single presentation, the gaming system comprising:
a touch screen display that displays video signals;
a curved display system including a curved transparent material, a projector for projecting video images onto the curved transparent material, and a lens positioned between the projector and the curved transparent material;
a primary video source generating a first video signal to be viewed on the curved display system;
a secondary video source generating a second video signal including secondary content to be viewed on the curved display system;
a touch router device in communication with the touch screen display; and
a display manager configured to scale at least one of the first video signal or the second video signal to a modified size and render the first video signal with the second video signal;
wherein the touch screen display receives an input that corresponds to coordinates and calculates a coordinate transformation on the coordinates that correspond to a determined source to accommodate any scaling performed on at least one of the first video signal or the second video signal, resulting in transformed coordinates.

15. The system of claim 14, wherein the curved display system further includes a first mirror positioned in the front of the display system and a second mirror positioned adjacent to the curved transparent material, wherein the video images from the projector are reflected off the first and second mirrors onto the curved transparent material.

16. The system of claim 14, wherein the display manager scales the first and second video signals to a desired size that conforms to the size and shape of the curved transparent material and renders the first video signal from the master gaming controller adjacent to the second video signal from the player tracking device in a split screen format.

17. The system of claim 14, wherein the display manager overlays the second video signal from the player tracking device on the first video signal from the master gaming controller on the curved display system.

18. A gaming system for presenting both game content-based video signals and secondary video signals in a single presentation, the gaming system comprising:
a curved display system including a curved transparent material and a projector for projecting video images onto the curved transparent material;
a touch screen system including a touch screen positioned in front of the curved transparent material;
a gaming controller generating a first video signal to be viewed on the curved display system;
a secondary video source generating a second video signal including secondary content to be viewed on the curved display system; and
a display manager configured to scale at least one of the first video signal or the second video signal to a reduced size and render the first video signal with the second video signal, wherein the display manager sends the first and second video signals to the projector for simultaneously displaying the first and second video signals on the curved transparent material, and
wherein the touch screen display receives an input that corresponds to coordinates and calculates a coordinate transformation on the coordinates that correspond to a determined source to accommodate any scaling performed on at least one of the first video signal or the second video signal.

19. The system of claim 18, wherein the display manager scales the first and second video signals to a desired size that conforms to the size and shape of the curved transparent material and renders the first video signal from the gaming controller adjacent to the second video signal from the secondary video source in a split screen format.

20. A gaming system for presenting first video signals and second video signals, comprising.
a video display having an associated touch screen interface configured to receive user input at touch coordinates on the touch screen interface;
a gaming controller configured to generate game-content related video signals for display on the video display;
a secondary video source for generating second video signals;
a touch router in communication with the touch screen interface;
a display manager in communication with the display, the controller and the secondary video source, the display manager configured to receive the video signals and scale at least one signal to a different size and present the first video second with the second video signal; and
wherein the touch screen display receives an input that corresponds to coordinates and calculates a coordinate transformation on the coordinates that correspond to a determined source to accommodate any scaling performed on the video signals.
